(19) United States
(12) Patent Application Publication
(10) Pub. No.: US 2024/0380544 A1
(43) Pub. Date: Nov. 14, 2024

(54) SUBBAND FULL DUPLEX CHANNEL STATE INFORMATION REFERENCE SIGNAL COMMUNICATION

(71) Applicant: QUALCOMM Incorporated, San Diego, CA (US)

(72) Inventors: Qian ZHANG, Basking Ridge, NJ (US); Yan ZHOU, San Diego, CA (US); Tao LUO, San Diego, CA (US)

(21) Appl. No.: 18/314,631

(22) Filed: May 9, 2023

(51) Int. Cl. H04L 5/00; H04B 17/336; H04L 5/14; H04W 24/10

(52) U.S. Cl. CPC H04L 5/0051; H04B 17/336; H04L 5/14; H04W 24/10

(57) ABSTRACT

Methods, systems, and devices for wireless communications are described. A user equipment (UE) and a network entity may support measurement and reporting of channel state information (CSI) in association with the communication of CSI reference signals (CSI-RSs) via subband full duplex (SBFD) time intervals. For example, the network entity may indicate, to the UE, a linkage of two or more CSI-RS resources across two or more downlink subbands of a SBFD time interval. The UE may transmit a report to the network based on two or more CSI-RSs received via the linked CSI-RS resources, where the report includes a single measurement metric based on the CSI-RS resources being linked. Additionally, or alternatively, the network entity may indicate respective CSI measurement configurations associated with SBFD and non-SBFD time intervals. The UE may report CSI for respective CSI-RSs received via SBFD or non-SBFD time intervals in accordance with respective measurement configurations.

### FIELD OF TECHNOLOGY

The following relates to wireless communications, including subband full duplex channel state information reference signal communication.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

A UE may support the communication of channel state information (CSI) with a network entity. In some cases, the network entity and the UE may support communicating in accordance with a subband full duplex (SBFD) configuration. Techniques for communicating CSI in accordance with an SBFD configuration may be desired.

### SUMMARY

The described techniques relate to improved methods, systems, devices, and apparatuses that support subband full duplex (SBFD) channel state information (CSI) reference signal (CSI-RS) communication. For example, a user equipment (UE) and a network entity may support SBFD communications in which two or more downlink subbands are non-contiguous (e.g. discontinuous) in a frequency domain, such as being separated by an uplink subband in the frequency domain, and at least partially overlapping in a time domain. To support the measurement and reporting of CSI in association with SBFD communications, the network entity may indicate, to the UE, two or more CSI-RS resources that are linked across the two or more downlink subbands, where CSI-RSs communicated via linked CSI-RS resources may be used to generate a single measurement metric (e.g., rather than a measurement metric per CSI-RS resource). As such, the UE may measure and report CSI that is associated with non-contiguous downlink subbands of a SBFD configuration. In some examples, CSI-RS resources may be linked in a same CSI reporting configuration, linked via an information element (IE) associated with one CSI-RS resource that indicates an identifier associated with another CSI-RS resource, or linked via a linkage identifier associated with the linked CSI-RS resources.

Additionally, or alternatively, the network entity may indicate, to the UE, respective CSI measurement and/or reporting configurations that are associated with SBFD and non-SBFD time intervals. For example, the network entity may indicate a first CSI measurement configuration associated with SBFD time intervals and a second CSI measurement configuration associated with non-SBFD time intervals. The UE may measure CSI-RSs in accordance with the first or second measurement configuration depending on whether the CSI-RSs are received via SBFD or non-SBFD time intervals. In some examples, the network entity may indicate a first and second reporting configuration associated with reporting CSI associated with SBFD and non-SBFD time intervals, respectively, and the UE may report CSI in accordance with the reporting configurations. In some examples, the network entity may indicate a same reporting configuration for reporting CSI associated with SBFD or non-SBFD time intervals. Here, the network entity may be aware of whether a CSI report is mapped to a SBFD or non-SBFD time interval.

A method for wireless communications at a UE is described. The method may include receiving a control message indicating that two or more CSI-RS resources are linked across two or more downlink subbands, the two or more downlink subbands being non-contiguous in a frequency domain and at least partially overlapping in a time domain, receiving two or more CSI-RSs via the two or more CSI-RS resources, and transmitting a report based on the two or more CSI-RSs, the report indicating a single measurement metric associated with the two or more CSI-RSs based on the control message indicating that the two or more CSI-RS resources are linked.

An apparatus for wireless communications at a UE is described. The apparatus may include a processor, memory coupled with the processor, and instructions stored in the memory. The instructions may be executable by the processor to cause the apparatus to receive a control message indicating that two or more CSI-RS resources are linked across two or more downlink subbands, the two or more downlink subbands being non-contiguous in a frequency domain and at least partially overlapping in a time domain, receive two or more CSI-RSs via the two or more CSI-RS resources, and transmit a report based on the two or more CSI-RSs, the report indicating a single measurement metric associated with the two or more CSI-RSs based on the control message indicating that the two or more CSI-RS resources are linked.

Another apparatus for wireless communications at a UE is described. The apparatus may include means for receiving a control message indicating that two or more CSI-RS resources are linked across two or more downlink subbands, the two or more downlink subbands being non-contiguous in a frequency domain and at least partially overlapping in a time domain, means for receiving two or more CSI-RSs via the two or more CSI-RS resources, and means for transmitting a report based on the two or more CSI-RSs, the report indicating a single measurement metric associated with the two or more CSI-RSs based on the control message indicating that the two or more CSI-RS resources are linked.

A non-transitory computer-readable medium storing code for wireless communications at a UE is described. The code may include instructions executable by a processor to receive a control message indicating that two or more CSI-RS resources are linked across two or more downlink subbands, the two or more downlink subbands being non-contiguous in a frequency domain and at least partially overlapping in a time domain, receive two or more CSI-RSs via the two or more CSI-RS resources, and transmit a report based on the two or more CSI-RSs, the report indicating a single measurement metric associated with the two or more CSI-RSs based on the control message indicating that the two or more CSI-RS resources are linked.

In some examples of the method, apparatuses, and non-transitory computer-readable medium described herein, the two or more CSI-RS resources may be linked in a same CSI reporting configuration indicated by the control message.

In some examples of the method, apparatuses, and non-transitory computer-readable medium described herein, the control message indicates that the two or more CSI-RS resources may be included in a same channel measurement resource (CMR) set or a same interference measurement resource (IMR) set associated with the two or more downlink subbands.

In some examples of the method, apparatuses, and non-transitory computer-readable medium described herein, the control message indicates that respective CSI-RS resources of the two or more CSI-RS resources associated with respective resource identifiers may be included in respective CMRs of a same CMR set or respective IMRs of a same IMR set associated with the two or more downlink subbands and the report indicates the single measurement metric associated with the two or more CSI-RSs based on the respective CMRs being of the same CMR set or the respective IMRs being of the same IMR set.

In some examples of the method, apparatuses, and non-transitory computer-readable medium described herein, the control message includes a flag indicating that the respective CMRs or the respective IMRs may be linked across the two or more downlink subbands.

In some examples of the method, apparatuses, and non-transitory computer-readable medium described herein, the control message indicates two CMRs and a single IMR and the single measurement metric corresponds to an average of respective measurement metrics associated with the two CMRs divided by a measurement metric associated with the single IMR.

In some examples of the method, apparatuses, and non-transitory computer-readable medium described herein, the control message indicates two CMRs and two IMRs and the single measurement metric corresponds to a first average of respective measurement metrics associated with the two CMRs divided by a second average of respective measurement metrics associated with the two IMRs.

In some examples of the method, apparatuses, and non-transitory computer-readable medium described herein, the control message indicates the two CMR and two IMRs in accordance with a rule that the control message indicates a same quantity of CMRs and IMRs as downlink subbands across which CSI-RS resources may be linked.

In some examples of the method, apparatuses, and non-transitory computer-readable medium described herein, the control message includes an information element (IE) associated with a first CSI-RS resource of the two or more CSI-RS resources, the IE including an identifier associated with a second CSI-RS resource of the two or more CSI-RS resources and the first CSI-RS resource and the second CSI-RS resource may be linked across the two or more downlink subbands based on the IE associated with the first CSI-RS resource including the identifier associated with the second CSI-RS resource.

In some examples of the method, apparatuses, and non-transitory computer-readable medium described herein, the control message includes a linkage identifier associated with the two or more CSI-RS resources that indicates the two or more CSI-RS resources may be linked.

Some examples of the method, apparatuses, and non-transitory computer-readable medium described herein may further include operations, features, means, or instructions for receiving a second control message including an IE indicating a set of linkage identifiers including the linkage identifier, each linkage identifier associated with a respective set of two or more CSI-RS resources that may be linked, where the control message includes the linkage identifier from the set of linkage identifiers indicated by the second control message.

Some examples of the method, apparatuses, and non-transitory computer-readable medium described herein may further include operations, features, means, or instructions for receiving a second control message that updates a linkage of CSI-RSs across the two or more downlink subbands to two or more second CSI-RS resources based on indicating a second linkage identifier associated with the two or more second CSI-RS resources, receiving two or more second CSI-RSs via the two or more second CSI-RS resources based on the second control message, and transmitting a second report based on the two or more second CSI-RSs, the second report indicating a single second measurement metric associated with the two or more second CSI-RSs.

In some examples of the method, apparatuses, and non-transitory computer-readable medium described herein, the second control message includes a medium access control-control element (MAC-CE) or downlink control information (DCI).

Some examples of the method, apparatuses, and non-transitory computer-readable medium described herein may further include operations, features, means, or instructions for receiving a second control message that updates a linkage of CSI-RSs across the two or more downlink subbands to two or more second CSI-RS resources based on indicating respective CSI-RS resource identifiers associated with the two or more second CSI-RS resources, receiving two or more second CSI-RSs via the two or more second CSI-RS resources based on the second control message, and transmitting a second report based on the two or more second CSI-RSs, the second report indicating a single second measurement metric associated with the two or more second CSI-RSs.

Some examples of the method, apparatuses, and non-transitory computer-readable medium described herein may further include operations, features, means, or instructions for removing a linkage of a first CSI-RS resource and a second CSI-RS resource of the two or more CSI-RS resources based on a CSI-RS resource identifier associated with the first CSI-RS resource being indicated by the second control message.

In some examples of the method, apparatuses, and non-transitory computer-readable medium described herein, the second control message includes a MAC-CE or DCI.

In some examples of the method, apparatuses, and non-transitory computer-readable medium described herein, one or more uplink subbands that overlap in a SBFD symbol with the two or more downlink subbands in the time domain may be located between respective downlink subbands of the two or more downlink subbands in the frequency domain.

A method for wireless communications at a UE is described. The method may include receiving at least one control message indicating a first measurement configuration for CSI measurement via a SBFD time interval and a second measurement configuration for CSI measurement via a non-SBFD time interval, the SBFD time interval including two or more downlink subbands that are non-contiguous in a frequency domain and at least partially overlap in a time domain, receiving one or more CSI-RSs via the SBFD time interval in accordance with the first measurement configuration or via the non-SBFD time interval in accordance with the second measurement configuration, and transmitting a report indicating CSI that is based on the one or more CSI-RSs.

An apparatus for wireless communications at a UE is described. The apparatus may include a processor, memory coupled with the processor, and instructions stored in the memory. The instructions may be executable by the processor to cause the apparatus to receive at least one control message indicating a first measurement configuration for CSI measurement via a SBFD time interval and a second measurement configuration for CSI measurement via a non-SBFD time interval, the SBFD time interval including two or more downlink subbands that are non-contiguous in a frequency domain and at least partially overlap in a time domain, receive one or more CSI-RSs via the SBFD time interval in accordance with the first measurement configuration or via the non-SBFD time interval in accordance with the second measurement configuration, and transmit a report indicating CSI that is based on the one or more CSI-RSs.

Another apparatus for wireless communications at a UE is described. The apparatus may include means for receiving at least one control message indicating a first measurement configuration for CSI measurement via a SBFD time interval and a second measurement configuration for CSI measurement via a non-SBFD time interval, the SBFD time interval including two or more downlink subbands that are non-contiguous in a frequency domain and at least partially overlap in a time domain, means for receiving one or more CSI-RSs via the SBFD time interval in accordance with the first measurement configuration or via the non-SBFD time interval in accordance with the second measurement configuration, and means for transmitting a report indicating CSI that is based on the one or more CSI-RSs.

A non-transitory computer-readable medium storing code for wireless communications at a UE is described. The code may include instructions executable by a processor to receive at least one control message indicating a first measurement configuration for CSI measurement via a SBFD time interval and a second measurement configuration for CSI measurement via a non-SBFD time interval, the SBFD time interval including two or more downlink subbands that are non-contiguous in a frequency domain and at least partially overlap in a time domain, receive one or more CSI-RSs via the SBFD time interval in accordance with the first measurement configuration or via the non-SBFD time interval in accordance with the second measurement configuration, and transmit a report indicating CSI that is based on the one or more CSI-RSs.

In some examples of the method, apparatuses, and non-transitory computer-readable medium described herein, the first measurement configuration indicates a first quantity of antenna ports or a first antenna configuration to use for CSI measurement via the SBFD time interval and the second measurement configuration indicates a second quantity of antenna ports or a second antenna configuration to use for CSI measurement via the non-SBFD time interval.

In some examples of the method, apparatuses, and non-transitory computer-readable medium described herein, the first measurement configuration indicates a first transmission configuration indicator (TCI) state associated with CSI measurement via the SBFD time interval and the second measurement configuration indicates a second TCI state associated with CSI measurement via the non-SBFD time interval.

In some examples of the method, apparatuses, and non-transitory computer-readable medium described herein, the first TCI state may be associated with first quasi co location (QCL) information associated with the SBFD time interval and the second TCI state may be associated with second QCL information associated with the non-SBFD time interval.

Some examples of the method, apparatuses, and non-transitory computer-readable medium described herein may further include operations, features, means, or instructions for receiving at least one second control message indicating a first reporting configuration for CSI associated with the SBFD time interval and a second reporting configuration for CSI associated with the non-SBFD time interval, where the report may be transmitted in accordance with the first reporting configuration or the second reporting configuration.

In some examples of the method, apparatuses, and non-transitory computer-readable medium described herein, the first reporting configuration indicates for the UE to measure CSI-RSs received via the SBFD time interval and to refrain from measuring CSI-RSs received via the non-SBFD time interval, the second reporting configuration indicates for the UE to refrain from measuring CSI-RSs received via the SBFD time interval and to measure CSI-RSs received via the non-SBFD time interval, and the one or more CSI-RSs may be measured in accordance with the first reporting configuration or the second reporting configuration.

Some examples of the method, apparatuses, and non-transitory computer-readable medium described herein may further include operations, features, means, or instructions for receiving at least one second control message indicating a reporting configuration for CSI associated with the SBFD time interval and the non-SBFD time interval, where the CSI indicated by the report includes first CSI associated with the SBFD time interval or second CSI associated with the non-SBFD time interval based on the reporting configuration being for CSI associated with the SBFD time interval and the non-SBFD time interval.

Some examples of the method, apparatuses, and non-transitory computer-readable medium described herein may further include operations, features, means, or instructions for disabling, based on the reporting configuration being for CSI associated with the SBFD time interval and the non-SBFD time interval, averaging the first CSI associated with the SBFD time interval and the second CSI associated with the non-SBFD time interval.

In some examples of the method, apparatuses, and non-transitory computer-readable medium described herein, one or more uplink subbands that overlap in a SBFD symbol with the two or more downlink subbands in the time domain may be located between respective downlink subbands of the two or more downlink subbands in the frequency domain.

A method for wireless communications at a network entity is described. The method may include transmitting a control message indicating that two or more CSI-RS resources are linked across two or more downlink subbands, the two or more downlink subbands being non-contiguous in a frequency domain and at least partially overlapping in a time domain, transmitting two or more CSI-RSs via the two or more CSI-RS resources, and receiving a report based on the two or more CSI-RSs, the report indicating a single measurement metric associated with the two or more CSI-RSs based on the control message indicating that the two or more CSI-RS resources are linked.

An apparatus for wireless communications at a network entity is described. The apparatus may include a processor, memory coupled with the processor, and instructions stored in the memory. The instructions may be executable by the processor to cause the apparatus to transmit a control message indicating that two or more CSI-RS resources are linked across two or more downlink subbands, the two or more downlink subbands being non-contiguous in a frequency domain and at least partially overlapping in a time domain, transmit two or more CSI-RSs via the two or more CSI-RS resources, and receive a report based on the two or more CSI-RSs, the report indicating a single measurement metric associated with the two or more CSI-RSs based on the control message indicating that the two or more CSI-RS resources are linked.

Another apparatus for wireless communications at a network entity is described. The apparatus may include means for transmitting a control message indicating that two or more CSI-RS resources are linked across two or more downlink subbands, the two or more downlink subbands being non-contiguous in a frequency domain and at least partially overlapping in a time domain, means for transmitting two or more CSI-RSs via the two or more CSI-RS resources, and means for receiving a report based on the two or more CSI-RSs, the report indicating a single measurement metric associated with the two or more CSI-RSs based on the control message indicating that the two or more CSI-RS resources are linked.

A non-transitory computer-readable medium storing code for wireless communications at a network entity is described. The code may include instructions executable by a processor to transmit a control message indicating that two or more CSI-RS resources are linked across two or more downlink subbands, the two or more downlink subbands being non-contiguous in a frequency domain and at least partially overlapping in a time domain, transmit two or more CSI-RSs via the two or more CSI-RS resources, and receive a report based on the two or more CSI-RSs, the report indicating a single measurement metric associated with the two or more CSI-RSs based on the control message indicating that the two or more CSI-RS resources are linked.

In some examples of the method, apparatuses, and non-transitory computer-readable medium described herein, the two or more CSI-RS resources may be linked in a same CSI reporting configuration indicated by the control message.

In some examples of the method, apparatuses, and non-transitory computer-readable medium described herein, the control message indicates that the two or more CSI-RS resources may be included in a same CMR set or a same IMR set associated with the two or more downlink subbands.

In some examples of the method, apparatuses, and non-transitory computer-readable medium described herein, the control message indicates that respective CSI-RS resources of the two or more CSI-RS resources associated with respective resource identifiers may be included in respective CMRs of a same CMR set or respective IMRs of a same IMR set associated with the two or more downlink subbands and the report indicates the single measurement metric associated with the two or more CSI-RSs based on the respective CMRs being of the same CMR set or the respective IMRs being of the same IMR set.

In some examples of the method, apparatuses, and non-transitory computer-readable medium described herein, the control message includes a flag indicating that the respective CMRs or the respective IMRs may be linked across the two or more downlink subbands.

In some examples of the method, apparatuses, and non-transitory computer-readable medium described herein, the control message indicates two CMRs and a single IMR and the single measurement metric corresponds to an average of respective measurement metrics associated with the two CMRs divided by a measurement metric associated with the single IMR.

In some examples of the method, apparatuses, and non-transitory computer-readable medium described herein, the control message indicates two CMRs and two IMRs and the single measurement metric corresponds to a first average of respective measurement metrics associated with the two CMRs divided by a second average of respective measurement metrics associated with the two IMRs.

In some examples of the method, apparatuses, and non-transitory computer-readable medium described herein, the control message indicates the two CMR and two IMRs in accordance with a rule that the control message indicates a same quantity of CMRs and IMRs as downlink subbands across which CSI-RS resources may be linked.

In some examples of the method, apparatuses, and non-transitory computer-readable medium described herein, the control message includes an IE associated with a first CSI-RS resource of the two or more CSI-RS resources, the IE including an identifier associated with a second CSI-RS resource of the two or more CSI-RS resources and the first CSI-RS resource and the second CSI-RS resource may be linked across the two or more downlink subbands based on the IE associated with the first CSI-RS resource including the identifier associated with the second CSI-RS resource.

In some examples of the method, apparatuses, and non-transitory computer-readable medium described herein, the control message includes a linkage identifier associated with the two or more CSI-RS resources that indicates the two or more CSI-RS resources may be linked.

Some examples of the method, apparatuses, and non-transitory computer-readable medium described herein may further include operations, features, means, or instructions for transmitting a second control message including an IE indicating a set of linkage identifiers including the linkage identifier, each linkage identifier associated with a respective set of two or more CSI-RS resources that may be linked, where the control message includes the linkage identifier from the set of linkage identifiers indicated by the second control message.

Some examples of the method, apparatuses, and non-transitory computer-readable medium described herein may further include operations, features, means, or instructions for transmitting a second control message that updates a linkage of CSI-RSs across the two or more downlink subbands to two or more second CSI-RS resources based on indicating a second linkage identifier associated with the two or more second CSI-RS resources, transmitting two or more second CSI-RSs via the two or more second CSI-RS resources based on the second control message, and receiving a second report based on the two or more second CSI-RSs, the second report indicating a single second measurement metric associated with the two or more second CSI-RSs.

In some examples of the method, apparatuses, and non-transitory computer-readable medium described herein, the second control message includes a MAC-CE or DCI.

Some examples of the method, apparatuses, and non-transitory computer-readable medium described herein may further include operations, features, means, or instructions for transmitting a second control message that updates a linkage of CSI-RSs across the two or more downlink subbands to two or more second CSI-RS resources based on indicating respective CSI-RS resource identifiers associated with the two or more second CSI-RS resources, transmitting two or more second CSI-RSs via the two or more second CSI-RS resources based on the second control message, and receiving a second report based on the two or more second CSI-RSs, the second report indicating a single second measurement metric associated with the two or more second CSI-RSs.

Some examples of the method, apparatuses, and non-transitory computer-readable medium described herein may further include operations, features, means, or instructions for removing a linkage of a first CSI-RS resource and a second CSI-RS resource of the two or more CSI-RS resources based on a CSI-RS resource identifier associated with the first CSI-RS resource being indicated by the second control message.

In some examples of the method, apparatuses, and non-transitory computer-readable medium described herein, the second control message includes a MAC-CE or DCI.

In some examples of the method, apparatuses, and non-transitory computer-readable medium described herein, one or more uplink subbands that overlap in a SBFD symbol with the two or more downlink subbands in the time domain may be located between respective downlink subbands of the two or more downlink subbands in the frequency domain.

A method for wireless communications at a network entity is described. The method may include transmitting at least one control message indicating a first measurement configuration for CSI measurement via a SBFD time interval and a second measurement configuration for CSI measurement via a non-SBFD time interval, the SBFD time interval including two or more downlink subbands that are non-contiguous in a frequency domain and at least partially overlap in a time domain, transmitting one or more CSI-RSs via the SBFD time interval or via the non-SBFD time interval, and receiving, in accordance with the first measurement configuration or the second measurement configuration, a report indicating CSI that is based on the one or more CSI-RSs.

An apparatus for wireless communications at a network entity is described. The apparatus may include a processor, memory coupled with the processor, and instructions stored in the memory. The instructions may be executable by the processor to cause the apparatus to transmit at least one control message indicating a first measurement configuration for CSI measurement via a SBFD time interval and a second measurement configuration for CSI measurement via a non-SBFD time interval, the SBFD time interval including two or more downlink subbands that are non-contiguous in a frequency domain and at least partially overlap in a time domain, transmit one or more CSI-RSs via the SBFD time interval or via the non-SBFD time interval, and receive, in accordance with the first measurement configuration or the second measurement configuration, a report indicating CSI that is based on the one or more CSI-RSs.

Another apparatus for wireless communications at a network entity is described. The apparatus may include means for transmitting at least one control message indicating a first measurement configuration for CSI measurement via a SBFD time interval and a second measurement configuration for CSI measurement via a non-SBFD time interval, the SBFD time interval including two or more downlink subbands that are non-contiguous in a frequency domain and at least partially overlap in a time domain, means for transmitting one or more CSI-RSs via the SBFD time interval or via the non-SBFD time interval, and means for receiving, in accordance with the first measurement configuration or the second measurement configuration, a report indicating CSI that is based on the one or more CSI-RSs.

A non-transitory computer-readable medium storing code for wireless communications at a network entity is described. The code may include instructions executable by a processor to transmit at least one control message indicating a first measurement configuration for CSI measurement via a SBFD time interval and a second measurement configuration for CSI measurement via a non-SBFD time interval, the SBFD time interval including two or more downlink subbands that are non-contiguous in a frequency domain and at least partially overlap in a time domain, transmit one or more CSI-RSs via the SBFD time interval or via the non-SBFD time interval, and receive, in accordance with the first measurement configuration or the second measurement configuration, a report indicating CSI that is based on the one or more CSI-RSs.

In some examples of the method, apparatuses, and non-transitory computer-readable medium described herein, the first measurement configuration indicates a first quantity of antenna ports or a first antenna configuration to use for CSI measurement via the SBFD time interval and the second measurement configuration indicates a second quantity of antenna ports or a second antenna configuration to use for CSI measurement via the non-SBFD time interval.

In some examples of the method, apparatuses, and non-transitory computer-readable medium described herein, the first measurement configuration indicates a first TCI state associated with CSI measurement via the SBFD time interval and the second measurement configuration indicates a second TCI state associated with CSI measurement via the non-SBFD time interval.

In some examples of the method, apparatuses, and non-transitory computer-readable medium described herein, the first TCI state may be associated with first quasi co location information associated with the SBFD time interval and the second TCI state may be associated with second quasi co location information associated with the non-SBFD time interval.

Some examples of the method, apparatuses, and non-transitory computer-readable medium described herein may further include operations, features, means, or instructions for transmitting at least one second control message indicating a first reporting configuration for CSI associated with the SBFD time interval and a second reporting configuration for CSI associated with the non-SBFD time interval, where the report may be received in accordance with the first reporting configuration or the second reporting configuration.

In some examples of the method, apparatuses, and non-transitory computer-readable medium described herein, the first reporting configuration indicates for measurement of CSI-RSs transmitted via the SBFD time interval and lack of measurement of CSI-RSs transmitted via the non-SBFD time interval and the second reporting configuration indicates for measurement of CSI-RSs transmitted via the SBFD time interval and lack of measurement of CSI-RSs transmitted via the non-SBFD time interval.

Some examples of the method, apparatuses, and non-transitory computer-readable medium described herein may further include operations, features, means, or instructions for transmitting at least one second control message indicating a reporting configuration for CSI associated with the SBFD time interval and the non-SBFD time interval, where the CSI indicated by the report includes first CSI associated with the SBFD time interval or second CSI associated with the non-SBFD time interval based on the reporting configuration being for CSI associated with the SBFD time interval and the non-SBFD time interval.

Some examples of the method, apparatuses, and non-transitory computer-readable medium described herein may further include operations, features, means, or instructions for determining whether the report includes the first CSI or the second CSI based on whether the one or more CSI-RSs may be transmitted via the SBFD time interval or the non-SBFD time interval.

In some examples of the method, apparatuses, and non-transitory computer-readable medium described herein, one or more uplink subbands that overlap in a SBFD symbol with the two or more downlink subbands in the time domain may be located between respective downlink subbands of the two or more downlink subbands in the frequency domain.

### BRIEF DESCRIPTION OF THE DRAWINGS

FIGS. 1 and 2 show examples of wireless communications systems that supports subband full duplex (SBFD) channel state information (CSI) reference signal (CSI-RS) communication in accordance with one or more aspects of the present disclosure.

FIG. 3 shows an example of a subband diagram that supports SBFD CSI-RS communication in accordance with one or more aspects of the present disclosure.

FIG. 4 shows an example of a time interval diagram that supports SBFD CSI-RS communication in accordance with one or more aspects of the present disclosure.

FIGS. 5 and 6 show examples of process flows that supports SBFD CSI-RS communication in accordance with one or more aspects of the present disclosure.

FIGS. 7 and 8 show block diagrams of devices that support SBFD CSI-RS communication in accordance with one or more aspects of the present disclosure.

FIG. 9 shows a block diagram of a communications manager that supports SBFD CSI-RS communication in accordance with one or more aspects of the present disclosure.

FIG. 10 shows a diagram of a system including a device that supports SBFD CSI-RS communication in accordance with one or more aspects of the present disclosure.

FIGS. 11 and 12 show block diagrams of devices that support SBFD CSI-RS communication in accordance with one or more aspects of the present disclosure.

FIG. 13 shows a block diagram of a communications manager that supports SBFD CSI-RS communication in accordance with one or more aspects of the present disclosure.

FIG. 14 shows a diagram of a system including a device that supports SBFD CSI-RS communication in accordance with one or more aspects of the present disclosure.

FIGS. 15 through 24 show flowcharts illustrating methods that support SBFD CSI-RS communication in accordance with one or more aspects of the present disclosure.

### DETAILED DESCRIPTION

Some wireless communications systems support various types of full duplex communication, including subband full duplex (SBFD) communications. For example, SBFD communications may support concurrent transmission and reception on a subband basis. Specifically, SBFD communications may include concurrent communication of downlink signaling via one or more downlink subbands and uplink signaling via one or more uplink subbands. In some examples of SBFD communications, two downlink subbands may be non-contiguous in the frequency domain, for example, due to being separated by an uplink subband in the frequency domain. Conventionally, contiguous channel state information (CSI) reference signal (CSI-RS) resources across a single downlink frequency band may be configured for CSI-RS measurement and reporting. As such, it may be ambiguous as to how configure CSI-RS resources for measurement and reporting, how to measure CSI-RSs, and how to report CSI if communicating CSI-RSs via non-contiguous downlink subbands in the frequency domain.

Techniques, systems, and devices described herein support the configuration of CSI-RS resources that are linked across non-contiguous (e.g., discontinuous) downlink subbands such that CSI measurement and reporting in association with SBFD communications may be supported. For example, a network entity may indicate, to a user equipment (UE), two or more CSI-RS resources that are linked across the two or more non-contiguous downlink subbands of a SBFD time interval. CSI-RSs communicated via linked CSI-RS resources may be used to generate a single measurement metric (e.g., rather than a measurement metric per CSI-RS resource). For example, the UE may generate CSI that is based on CSI-RS measurements in each of the linked CSI-RS resources (e.g., rather than generating respective CSI associated with each CSI-RS resource). As such, the UE may measure and report CSI that is associated with non-contiguous downlink subbands of a SBFD configuration. In some examples, network entity may indicate a linkage of CSI-RS resources by linking the CSI-RS resources in a same CSI reporting configuration (e.g., by including multiple CSI-RS resources to a same channel measurement resource (CMR) set or a same interference measurement resource (IMR) set, by including CSI-RS resources in respective CMRs of a same CMR set or in respective IMRs or a same IMR set), linking the CSI-RS resources in an information element (IE) associated with one CSI-RS resource that indicates an identifier associated with another CSI-RS resource, or linking the CSI-RS resources via a linkage identifier associated with the linked CSI-RS resources.

By supporting the configuration of linked CSI-RS resources across downlink subbands that are non-contiguous in the frequency domain and overlapping in the time domain, accurate CSI measurement and reporting may be supported in association with SBFD communications. Accurate CSI reporting may enable a network entity to efficiently configure and schedule communications with UEs served by the network entity, for example, by indicating information about respective channel conditions to the network entity that may be used to schedule the communications. As such, the configuration and scheduling of SBFD communications, which support latency reduction (e.g., due to increased uplink and/or downlink duty cycle), uplink and downlink coverage improvement, higher data rates, and increased capacity and spectrum efficiency, among other benefits, may be improved. Additionally, the efficiency of resources scheduled in association with the SBFD communications may be improved, such as by supporting flexible and dynamic uplink and downlink resource adaptation in accordance with uplink and downlink traffic and reported channel conditions.

Additionally or alternatively, techniques, systems, and devices described herein support the indication of respective CSI measurement and/or reporting configurations associated with SBFD and non-SBFD time intervals. For example, the network entity may indicate a first measurement configuration associated with measuring CSI-RSs transmitted via (e.g., during) SBFD time intervals (e.g., slots, symbols) and a second measurement configuration associated with measuring CSI-RSs transmitted via non-SBFD time intervals. In some examples, the first and second measurement configurations may indicate different antenna (e.g., antenna port) configurations, different transmission configuration indicator (TCI) states, or a combination thereof, for receiving and measuring CSI-RSs. The UE may measure CSI-RSs in accordance with the first or second measurement configuration depending on whether the CSI-RSs are received via SBFD or non-SBFD time intervals. In some examples, the network entity may indicate a first and second reporting configuration associated with reporting CSI mapped to a CSI occasion in a SBFD or non-SBFD time interval, respectively, and the UE may report CSI in accordance with the reporting configurations. In some examples, the network entity may indicate a same reporting configuration for reporting CSI mapped to either a SBFD or non-SBFD time interval. Here, the network entity may be aware of whether a CSI report is mapped to SBFD or non-SBFD time interval.

Different CSI-RS resources may be allocated for SBFD time intervals as compared to non-SBFD time intervals. Thus, by supporting the configuration of respective CSI measurement configurations for SBFD and non-SBFD time intervals, CSI measurement and reporting accuracy may be increased in association with SBFD and non-SBFD communications, such as by adjusting CSI-RS measurement in accordance with the different CSI-RS resource allocations. As such, the configuration and scheduling of SBFD communications may be improved. Additionally, by supporting the configuration of separate reporting configurations or a same reporting configuration (with network entity awareness of report to CSI occasion mapping), CSI reporting for SBFD and non-SBFD time intervals may be differentiated to increase CSI reporting accuracy, among other benefits.

In some examples, the configuration of CSI measurement and/or reporting configurations for SBFD time intervals may be independent of whether CSI-RS resources are linked across non-contiguous downlink subbands in the frequency domain. For example, in some cases of an SBFD time interval, multiple CSI-RS resources may be linked across multiple non-contiguous downlink subbands in the frequency domain. In other cases of an SBFD time interval, one non-contiguous CSI-RS resource may be allocated across multiple non-contiguous downlink subbands in the frequency domain. In still some other cases of an SBFD time interval, one contiguous CSI-RS resource may be allocated across multiple non-contiguous downlink subbands in the frequency domain, where a non-contiguous portion of the CSI-RS resource may be derived by excluding frequency resources outside of the downlink subbands. In some examples, CSI measurement and/or reporting configurations may be indicated for SBFD time intervals, such as regardless of how CSI-RS resources are allocated for the SBFD time intervals.

Aspects of the disclosure are initially described in the context of wireless communications systems. Aspects of the disclosure are additionally described in the context of a subband diagram, a time interval diagram, and process flows. Aspects of the disclosure are further illustrated by and described with reference to apparatus diagrams, system diagrams, and flowcharts that relate to SBFD CSI-RS communication.

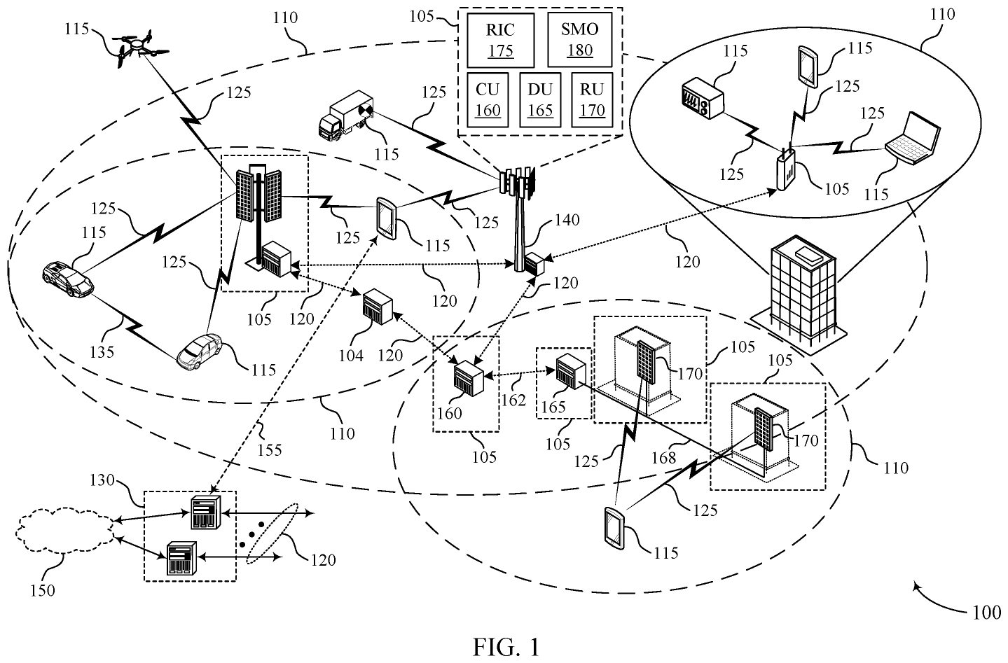

FIG. 1 shows an example of a wireless communications system 100 that supports SBFD CSI-RS communication in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support SBFD CSI-RS communication as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Ts=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The wireless communications system 100 may support the communication of CSI between communication devices. For example, communication devices (e.g., network entities 105, UEs 115) may exchange CSI (e.g., a network entity 105 may gather CSI from a UE 115, UEs 115 may exchange CSI) to efficiently configure and schedule the channel. In some examples, this information may be sent from a UE 115 in the form of a CSI report. A CSI report may contain: a rank indicator (RI) requesting a number of layers to be used for transmissions (e.g., based on antenna ports of the UE 115); a layer indicator (LI) indicating a strongest layer of the number of layers requested by the RI; a precoding matrix indicator (PMI) indicating a preference for which precoder matrix should be used (e.g., based on a number of layers); a channel quality indicator (CQI) representing a highest modulation and coding scheme (MCS) that may be used; a CSI-RS resource indicator (CRI) indicating a preferred beam for communicating with a communication device (e.g., a network entity 105, another UE 115); a synchronization signal block (SSB) resource indicator (SSBRI) indicating an SSB that the UE 115 receives with a highest received power (e.g., reference signal received power (RSRP); an RSRP associated with the preferred beam; an RSRP associated with the SSB; a signal-to-interference-plus-noise ratio (SINR) associated with the preferred beam; an SINR associated with the SSB; or a combination thereof, among other types of CSI.

In some cases, an RI may be associated with a number of antennas used by a device. CQI may be calculated by a UE 115 in response to receiving predetermined pilot symbols such as cell-specific reference signals (CRS) or CSI-RSs. RI and PMI may be excluded if the UE 115 does not support spatial multiplexing (or is not in a supported spatial mode). In some examples, the types of information included in the CSI report may determine a reporting type (e.g., a type I CSI report, a type II CSI report, and so on).

The wireless communications system 100 may support communication in accordance with various duplexing configurations (e.g., schemes), such as a half-duplex configuration or a full duplex configuration. In some examples, the wireless communications system 100 may support SBFD configurations in which two or more downlink subbands are separated by one or more uplink subbands (e.g., and corresponding guard bands) in the frequency domain, where a downlink subband may correspond to a frequency subband via which downlink communications may be transmitted (e.g., to a UE 115) and an uplink subband may correspond to a frequency subband via which uplink communications may be transmitted (e.g., to a network entity 105). As such, a frequency allocation for downlink communications during such an SBFD configuration may be non-contiguous.

To support CSI measurement and reporting associated with non-contiguous downlink subbands (e.g., downlink subbands of an SBFD time interval), a network entity 105 may transmit a control message to a UE 115 that indicates a linkage of CSI-RS resources across the non-contiguous downlink subbands. Due to linkage of the CSI-RS resources, the UE 115 may measure CSI-RSs received via each of the linked CSI-RS resources and use the respective measurements to generate a single measurement metric (e.g., a single set of information included in a CSI report for the linked CSI-RS resources) that is associated with the each of CSI-RSs (e.g., the CSI-RS resources), such as rather than a respective measurement metric (e.g., a respective set of information included in the CSI report) that is associated with each respective CSI-RS (e.g., each CSI-RS resource).

Additionally, or alternatively, to support CSI measurement and reporting associated with SBFD time intervals, the network entity 105 may indicate different CSI measurement configurations for SBFD time intervals and non-SBFD time intervals. For example, the network entity 105 may indicate to the UE 115 different numbers of antenna ports, different antenna configurations, different TCI states, or a combination thereof, to be used in association with measuring CSI-RSs received via SBFD time intervals as compared to CSI-RSs received via non-SBFD time intervals. As such, CSI measurement may be adapted to consider (e.g., accommodate for) different downlink frequency resource allocations for communicating CSI-RSs via SBFD time intervals as compared to non-SBFD time intervals.

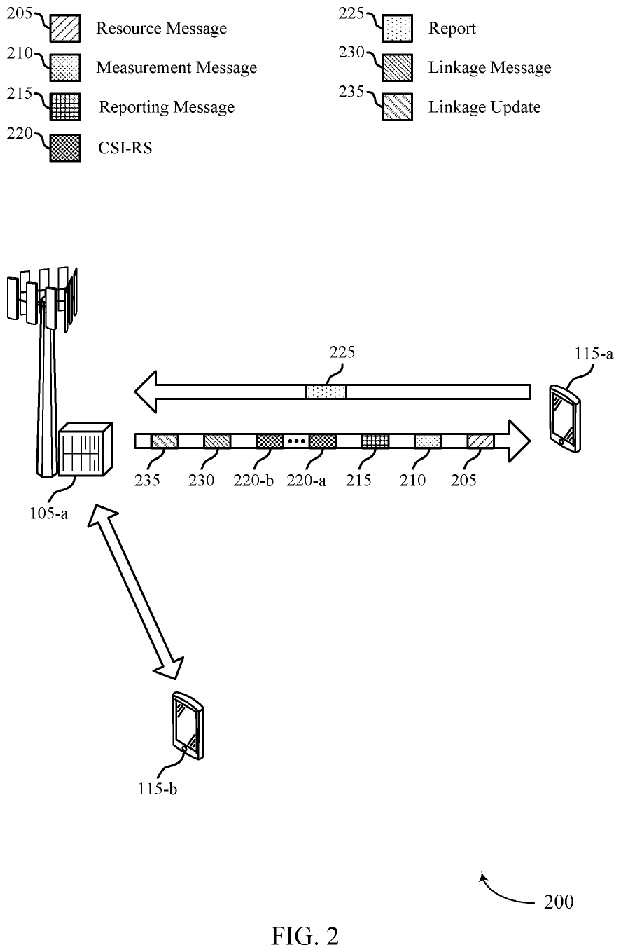

FIG. 2 shows an example of a wireless communications system 200 that supports SBFD CSI-RS communication in accordance with one or more aspects of the present disclosure. The wireless communications system 200 may implement or be implemented by aspects of the wireless communications system 100. For example, the wireless communications system 200 may include a network entity 105-a, a UE 115-a, and a UE 115-b, which may be examples of the corresponding devices described herein, including with reference to FIG. 1.

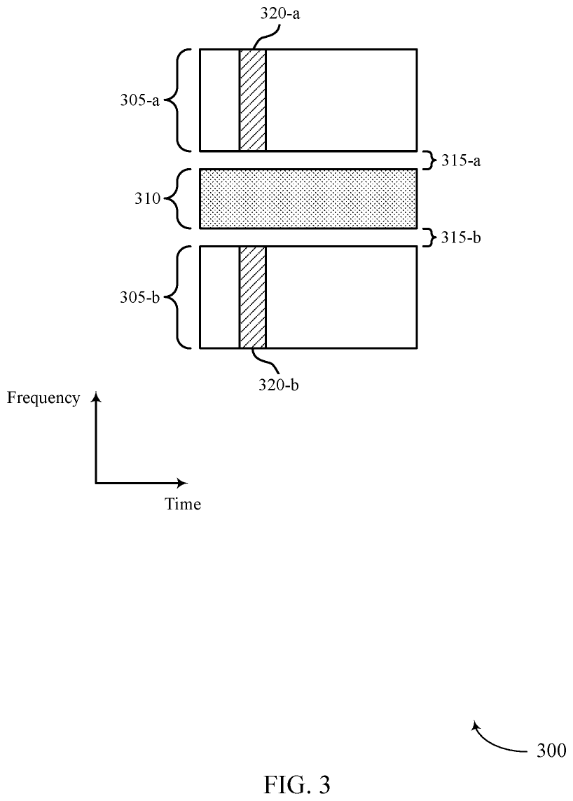

The network entity 105-a may support full duplex communications with the UEs 115. For example, the network entity 105-a may support concurrently transmitting a downlink message to the UE 115-a and receiving an uplink message from the UE 115-b, or vice versa. The network entity 105-a may support SBFD communications to support concurrent (e.g., simultaneous) transmission and reception of downlink and uplink messages on a subband basis. For example, in TDD or intra-band carrier aggregation configurations, a bandwidth (e.g., a TDD carrier bandwidth, a component carrier bandwidth) may include multiple subbands. In SBFD communications, one or more of the multiple subbands may be allocated as (e.g., configured as) downlink subbands, and one or more of the multiple subbands may be allocated as uplink subbands. In some examples of SBFD communications, two or more downlink subbands may be non-contiguous in the frequency domain. For example, downlink subbands may be separated by one or more uplink subbands (e.g., and corresponding guard bands), as described with reference to FIG. 3.

In some cases, full duplex communications, including SBFD communications, at the network entity 105-a may be subject to self-interference, such as a transmission beam of the network entity 105-a interfering with a reception beam of the network entity 105-a clutter. Additionally, or alternatively, the full duplex communication may be subject to clutter, such as a downlink message reflecting off a nearby object and interfering with concurrently transmitted uplink message. Self-interference and clutter may reduce a reliability of the full duplex communications. In some examples, accurate reporting of CSI from UEs 115 served by the network entity 105-a may enable the network entity 105-a to schedule and configure full duplex communications (e.g., configure communication parameters associated with the full duplex communications, such as beams, transmission powers, precoding matrices, MCSs, layers, and so on) such that self-interference and clutter (e.g., or the effects thereof) may be mitigated or reduced and reliability may be increased. As such, techniques for accurate measurement and reporting of CSI in association with SBFD communications may be desired.

The wireless communications system 200 may support the measurement and reporting of CSI based on the communication of CSI-RSs 220. For example, the network entity 105-a may transmit a CSI-RS 220 to the UE 115-a via a CSI-RS resource. The UE 115-a may measure the CSI-RS 220 and determine corresponding CSI to report (e.g., indicate) to the network entity 105-a via a report 225 based on the measurement. In some examples of SBFD communications, CSI-RSs 220 may be transmitted via two or more downlink subbands that are non-contiguous in the frequency domain and at least partially overlapping in the time domain. Whereas for non-SBFD communications, CSI-RSs 220 may be transmitted via a downlink bandwidth (e.g., a downlink subband) that is contiguous in the frequency domain.

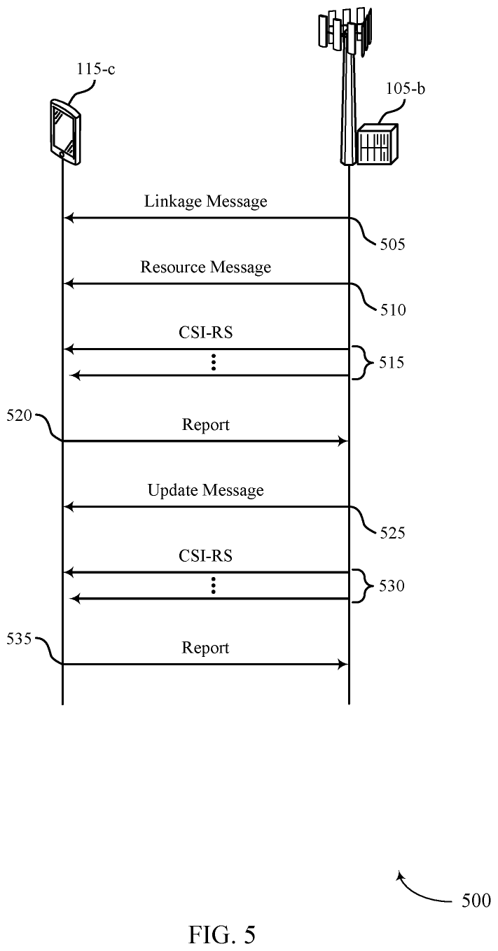

To support the measurement of CSI-RSs 220 via non-contiguous downlink subbands, the network entity 105-a may transmit a resource message 205 (e.g., a control message, such as an RRC message) to the UE 115-a. The resource message 205 may indicate a configuration of two or more CSI-RS resources that are linked across the two or more downlink subbands. For example, the resource message 205 may indicate a linkage of the two or more CSI-RS resources by linking the CSI-RS resources in a same CSI reporting configuration, linking the CSI-RS resources via an IE associated with one CSI-RS resource that indicates one or more identifiers associated with one or more other CSI-RS resources, or linking the CSI-RS resources via a linkage identifier associated with the linked CSI-RS resources. In some examples, the network entity 105-a may transmit a linkage message 230 that indicates a set of linkage identifiers that are each associated with (e.g., indicate a linkage of) a respective set of two or more CSI-RS resources, and the resource message 205 may indicate the linkage identifier from the set of linkage identifiers indicated by the linkage message 230. Additional details related to techniques for indicating the linkage of CSI-RS resources across non-contiguous downlink subbands in the frequency domain are described with reference to FIGS. 3 and 5.

The linkage of the two or more CSI-RS resources across the two or more downlink subbands may indicate for the UE 115-a to generate a single measurement metric associated with the two or more CSI-RS resources. For example, the network entity 105-a may transmit two or more CSI-RSs 220 (e.g., a CSI-RS 220-a through a CSI-RS 220-b) via the two or more CSI-RS resources that are linked across the two or more downlink subbands. The UE 115-a may measure the CSI-RSs 220 and use the measurements to generate the single measurement metric (e.g., a single layer 1 (L1) metric). In some examples, the single measurement metric may include one or more types of CSI, such as one or more of an RI, an LI, a PMI, a CQI, a CRI, an SSBRI, an RSRP, a SINR, or a combination thereof, among other types of CSI. Here, each type of CSI included in the single measurement metric may be generated using the measurements (e.g., a combination of the measurements, an average of the measurements) of the CSI-RSs 220 based on the two or more CSI-RS resources via which the CSI-RSs 220 are communicated being linked. That is, due to the linkage of the two or more CSI-RS resources, the UE 115-a may generate a single measurement metric (e.g., a single SINR) for reporting to the network entity 105-a that is associated with multiple CSI-RSs 220 transmitted via the two or more CSI-RS resources, rather than generating a respective measurement metric per CSI-RS resource (e.g., one SINR per CSI-RS resource), such as in a multi-transmission reception point (TRP) scenario in which multiple CMRs are configured for multiple TRP measurements. The UE 115-a may transmit a report 225 (e.g., a CSI report) to the network entity 105-a that indicates the single measurement metric.

In some examples, the network entity 105-a may update a linkage of which CSI-RS resources are linked across the two or more downlink subbands (e.g., or other downlink subbands that are non-contiguous in the frequency domain and at least partially overlapping in the time domain). For example, the network entity 105-a may transmit a linkage update 235 to the UE 115-a, which may be a control message that indicates the update to the linkage. For instance, the linkage update 235 may indicate two or more second CSI-RS resources that are linked across the two or more downlink subbands. Based on (e.g., subsequent to, in response to) the linkage update 235, the network entity 105-a and the UE 115-a may communicate two or more second CSI-RSs 220 via the two or more second CSI-RS resources, and the UE 115-a may transmit a second report 225 to the network entity 105-a that indicates a single second measurement metric that is based on the two or more second CSI-RSs. In some examples, the linkage update 235 may be indicated via at least one of a MAC-control element (MAC-CE) or downlink control information (DCI). Additional details related to techniques for updating the linkage of CSI-RS resources across non-contiguous downlink subbands in the frequency domain are described with reference to FIGS. 3 and 5.

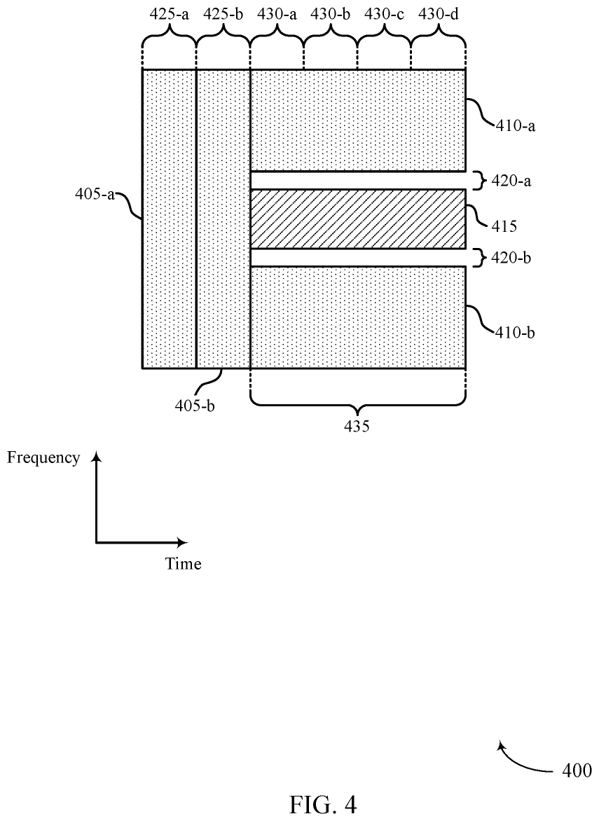

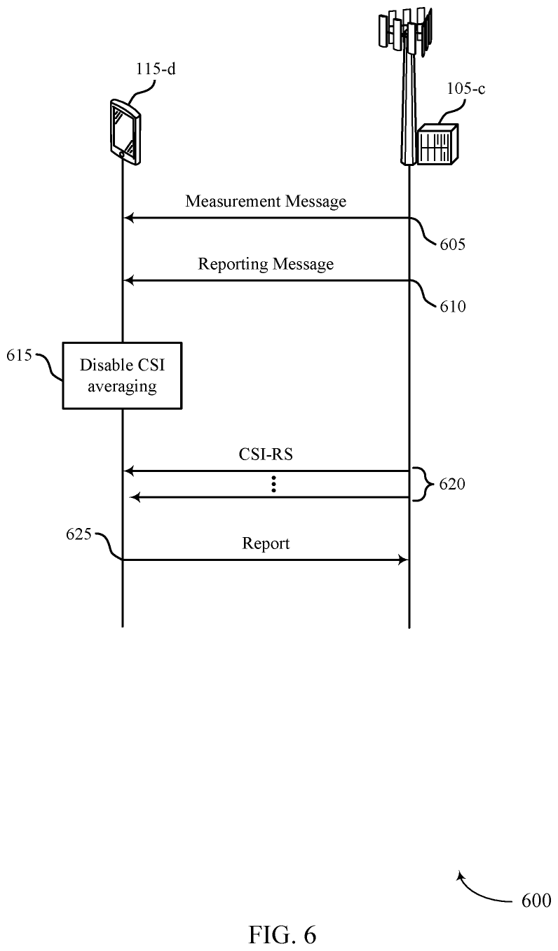

Additionally, or alternatively, to support the measurement of CSI-RSs 220 via non-contiguous downlink subbands, the network entity 105-a may transmit one or more measurement messages 210 (e.g., one or more control messages) to the UE 115-a. For example, the one or more measurement messages 210 may indicate a first measurement configuration for measuring CSI-RSs 220 communicated via (e.g., during) SBFD time intervals (e.g., SBFD slots, SBFD symbols) and a second measurement configuration for measuring CSI-RSs 220 communicated via non-SBFD time intervals. Accordingly, the UE 115-a may receive and measure one or more CSI-RSs 220 in accordance with the first measurement configuration or the second measurement configuration depending on whether the one or more CSI-RSs 220 are communicated via a SBFD or non-SBFD time interval. The UE 115-a may transmit a report 225 to the network entity 105-a that indicates CSI generated based on the measurements of the one or more CSI-RSs 220 performed in accordance with the first or second measurement configurations. Additional details related to measurement configurations for measuring CSI-RSs 220 in association with SBFD and non-SBFD communications are described with reference to FIGS. 4 and 6.

In some examples, to support the reporting of CSI that is based on CSI-RSs 220 communicated via non-contiguous downlink subbands, the network entity 105-a may transmit one or more reporting messages 215 (e.g., one or more control messages) to the UE 115-a. For example, the one or more reporting messages 210 may indicate separate reporting configurations (e.g., CSI report configurations) for reporting CSI associated with SBFD time intervals and CSI associated with non-SBFD time intervals. Alternatively, the one or more reporting messages 210 may indicate a same configuration for reporting CSI associated with SBFD time intervals and CSI associated with non-SBFD time intervals. The UE 115-a may transmit a report 225 in accordance with an indicated reporting configuration and a type of time interval (e.g., SBFD or non-SBFD) via which one or more CSI-RSs 220 are received. Additional details related to reporting configurations for reporting CSI in association with SBFD and non-SBFD communications are described with reference to FIGS. 4 and 6.

FIG. 3 shows an example of a subband diagram 300 that supports SBFD CSI-RS communication in accordance with one or more aspects of the present disclosure. The subband diagram 300 may be implemented by aspects of the wireless communications systems 100 or 200. For example, the subband diagram 300 may be implemented by a network entity 105 and a UE 115 as described herein, including with reference to FIGS. 1 through 2.

The subband diagram 300 depicts subbands of a SBFD configuration according to which the network entity 105 may perform (e.g., communicate) SBFD operations. For example, in the example of FIG. 3, the subband diagram 300 may include downlink subbands 305-a and 305-b and an uplink subband 310. It is noted that the subband diagram 300 may include any quantity of two or more downlink subbands 305 and any quantity of one or more uplink subbands 310.

The downlink subbands 305 may be non-contiguous in the frequency domain and at least partially overlapping in the time domain. For example, the downlink subband 305-a and the downlink subband 305-b may be separated by at least one uplink subband 310 (e.g., the uplink subband 310) in the frequency domain, where the uplink subband 310 at least partially overlaps in the time domain with the downlink subbands 305. The downlink subbands 305-a and 305-b may further be separated in the frequency domain by one or more guard bands 315. For example, a guard band 315-a may separate the uplink subband 310 and the downlink subband 305-a in the frequency domain, and a guard band 315-b may separate the uplink subband 310 and the downlink subband 305-b in the frequency domain. The guard bands 315 may be frequency bands via which no messages are communicated, such as to provide interference protection (e.g., reduction) between associated subbands.

The network entity 105 may indicate to the UE 115 (e.g., via a resource message 205) CSI-RS resources 320 that are located in (e.g., included in) the downlink subbands 305 and that are linked across the downlink subbands 305. For example, the network entity 105 may indicate a CSI-RS resource 320-a included in the downlink subband 305-a and a CSI-RS resources 320-b included in the downlink subband 305-b. The CSI-RS resource 320-a and the CSI-RS resources 320-b may be linked across the downlink subbands 305-a and 305-b. That is, the UE 115 may generate a single measurement metric to report to the network entity 105 from CSI-RSs that are received from the network entity 105 via the CSI-RS resources 320-a and 320-b, as described with reference to FIG. 2.

The UE 115 and the network entity 105 may support various techniques for linking the CSI-RS resources 320 across the downlink subbands 305. For example, the CSI-RS resources 320 may be linked in a same CSI reporting configuration indicated to the UE 115 by the network entity 105. For instance, the resource message 205 may indicate a CSI reporting configuration to the UE 115 (e.g., that includes parameters associated with reporting CSI to the network entity 105), and the CSI reporting configuration may indicate the linkage of the CSI-RS resources 320.

In some examples, the CSI-RS resources 320 may be linked in a same CSI reporting configuration by including two CSI-RS resources 320 in a same CMR set or a same IMR set. For example, a CMR may be a resource associated with CSI acquisition (e.g., a resource via which a CSI-RS for CSI acquisition may be transmitted). An IMR may be a resource associated with CSI-interference measurement (CSI-IM) acquisition and/or interference measurement acquisition (e.g., a resource via which a CSI-RS for CSI-IM or interference measurement acquisition may be transmitted). To link the CSI-RS resources, the CSI reporting configuration may include two CSI-RS resources 320 in a same CMR or a same IMR of a same CMR or IMR resource set associated with the two downlink subbands 305-a and 305-b.

In some other examples, the CSI-RS resources 320 may be linked in a same CSI reporting configuration by indicating that indicates that respective CSI-RS resources 320 are included in respective CMRs of a same CMR set or respective IMRs of a same IMR set associated with the two downlink subbands 305-a and 305-b. For example, two CMRs with two CSI-RS resource identifiers or two IMRs with two CSI-RS resource identifiers may be included in the same CMR set or the same IMR set associated with the downlink subbands 305-a and 305-b. In some examples, the resource message 205 may include a flag to indicate that the respective CMRs or IMRs (e.g., a first CMR or IMR associated with the CSI-RS resource 320-a and a second CMR or IMR associated with the CSI-RS resource 320-b) are linked across the downlink subbands 305-a and 305-b.

To address a CMR to IMR mapping, if the network entity 105 configures two CMRs for the two downlink subbands 305-a and 305-b plus one IMR, the single measurement metric may be determined (e.g., generate, computed, calculated) by averaging respective measurement metrics associated with the two CMRs and dividing by a measurement metric associated with the IMR. For example, the UE 115 may generate a first SINR associated with the first CMR, a second SINR associated with the second CMR, and a third SINR associated with the IMR. The UE 115 may average the first and second SINRs and divide the average SINR by the third SINR to generate a single SINR to report to the network entity 105.

Alternatively, a rule may be defined that if the network entity 105 configures two CMRs for the two downlink subbands 305-a and 305-b, then the network entity 105 configures two IMR resources. That is, the rule may indicate that network entity 105 configures (e.g., via the resource message 205) a same quantity of CMRs and IMRs as a quantity of downlink subbands 305 across which the CSI-RS resources 320 are linked. Here, the single measurement metric may be generated by dividing a first average of respective measurement metrics associated with the two CMRs by a second average of respective measurement metrics associated with the two IMRs. For example, the UE 115 may average respective SINRs associated with the two CMRs and divide the averaged SINR by the average of respective SINRs associated with the two IMRs to generate a single SINR to report to the network entity 105. Other averaging techniques are possible to generate to single SINR, such as dividing a first SINR associated with a first CMR by a first SINR associated with a first IMR and averaging the divided SINR with a value of a second SINR associated with second CMR divided by a second SINR associated with a second IMR.

In some examples, the CSI-RS resources 320 may be linked via RRC signaling. For example, the resource message 205 may include an IE associated with the CSI-RS resource 320-a that includes an identifier associated with the CSI-RS resource 320-b (e.g., a CSI-RS resource identifier of the CSI-RS resources 320-b). That is, in one of the CSI-RS resource RRC configuration IEs for one of the downlink subbands 305 (e.g., the IE for the CSI-RS resources 320-a in the downlink subband 305-a), a field may indicate the CSI-RS resource identifier included in the other downlink subband 305 (e.g., the CSI-RS resource identifier of the CSI-RS resource 320-b included in the downlink subband 305-b). The inclusion of the CSI-RS resource identifier of the CSI-RS resource 320-b in the IE associated with the CSI-RS resource 320-a may indicate that the CSI-RS resources 320-a and 320-b are linked.

In some other examples of linking the CSI-RS resources 320 via RRC signaling, the resource message 205 may include a linkage identifier that links the CSI-RS resources 320-a and 320-b. For example, within an IE different than an IE used to define (e.g., indicate) CSI-RS resources 320, the linkage identifier may be defined (e.g., indicated). The linkage identifier may be associated with the CSI-RS resource identifiers of the CSI-RS resources 320-a and 320-b. For example, the definition of the linkage identifier in the IE may include the CSI-RS resource identifiers of the CSI-RS resources 320-a and 320-b.

In some other examples, a set of linkage identifiers may be defined (e.g., indicated) in the IE used to define the CSI-RS resources 320 (e.g., via a linkage message 230), and each linkage identifier may be associated with (e.g., indicate a linkage between) a respective set of two or more CSI-RS resources 320. Here, the intended linkage identifier may be indicated (e.g., included) in a CSI reporting configuration to indicate which CSI-RS resources 320 are linked across the downlink subbands 305-a and 305-b. For example, the CSI reporting configuration may include a field that indicates a linkage identifier from the set of linkage identifiers that links the CSI-RS resources 320-a and 320-b across the downlink subbands 305-a and 305-b. Here, the resource message 205 may indicate the CSI reporting configuration and the linkage identifier.

In some examples, the linkage of CSI-RS resources 320 across the downlink subbands 305 may be updated. For example, the network entity 105 may transmit a linkage update 235 (e.g., via a MAC-CE, via DCI) that updates which CSI-RS resources 320 are linked across the downlink subbands 305. In some examples, the linkage update 235 may update a size of one or more of the downlink subbands 305. In some examples, the linkage update 235 may indicate a new linkage identifier of the set of linkage identifiers. In some examples, the linkage update 235 may define (e.g., indicate, include) a new linkage identifier associated with two new CSI-RS resource identifiers. In some examples, the linkage update 235 may indicate two or more new CSI-RS resource identifiers corresponding to new CSI-RS resources 320 that are linked across the downlink subbands 305-a and 305-b. For example, the linkage update 235 may indicate a pair of CSI-RS resource identifiers of a pair of CSI-RS resources 320 to be linked. In some examples one or more of the new CSI-RS resources 320 that are linked may be a same CSI-RS resource that was previously linked. For example, the linkage update 235 may indicate an updated linkage that links the CSI-RS resource 320-a with a new CSI-RS resource 320.

The UE 115 and the network entity 105 may remove a prior linkage of the CSI-RS resources 320 in response to linkage update 235. For example, if the CSI-RS resource 320-a has an ID1 and the CSI-RS resource 320-b has an ID7 and the linkage update 235 indicates a linkage of IDs 1 and 5, the UE 115 and the network entity 105 may remove (e.g., cancel) a linkage of the CSI-RS resources 320-a and 320-b (e.g., linkage of IDs 1 and 7 are removed).

FIG. 4 shows an example of a time interval diagram 400 that supports SBFD CSI-RS communication in accordance with one or more aspects of the present disclosure. The time interval diagram 400 may be implemented by aspects of the wireless communications systems 100 or 200. For example, the time interval diagram 400 may be implemented by a network entity 105 and a UE 115 as described herein, including with reference to FIGS. 1 through 3.

The time interval diagram 400 depicts subbands of a SBFD configuration according to which the network entity 105 may perform SBFD operations. For example, in the example of FIG. 4, the time interval diagram 400 may include downlink subbands 410-a and 410-b and an uplink subband 415, which may be examples of the downlink subbands 305 and the uplink subband 310. It is noted that the time interval diagram 400 may include any quantity of two or more downlink subbands 410 and any quantity of one or more uplink subbands 415. The downlink subbands 410-a and 410-b may also be separated by one or more guard bands 420 (e.g., 420-a and 420-b), which may be examples of guard bands 315-a and 315-b as described with reference to FIG. 3).

The time interval diagram 400 also depicts downlink bandwidths 405 of a non-SBFD configuration according to which the network entity 105 may perform non-SBFD operations. For example, in the example of FIG. 4, the time interval diagram 400 may include downlink bandwidths 405-a and 405-b corresponding to non-SBFD time intervals 425 (e.g., 425-a and 425-b, respectively) and via which the network entity 105 may transmit downlink messages (e.g., CSI-RSs) to the UE 115. In some examples, the downlink bandwidths 405 may span multiple subbands, such as spanning the downlink subbands 305 and the uplink subband in the frequency domain.

The time interval diagram 400 depicts SBFD time intervals 430 and 435 (e.g., SBFD time intervals 430-a, 430-b, 430-c, and 430-d) and non-SBFD time intervals 425. Non-SBFD time intervals 425 may correspond to time intervals, such as slots or symbols (among other time intervals), during which the network entity 105 may transmit downlink messages or receive uplink messages, such as in accordance with a half-duplex configuration. SBFD time intervals 430 and 435 may be time intervals during which the network entity 105 may concurrently transmit and receive downlink and uplink messages. In the example of FIG. 4, SBFD time intervals 430 may correspond to symbols and the SBFD time intervals 435 may correspond to a slot (e.g., that includes the SBFD time intervals 430-a through 430-d). In the example of FIG. 4, the non-SBFD time intervals 425 are represented as symbols, however, other time intervals, such as slots, are possible for the non-SBFD time intervals 425.

The network entity 105 may configure (e.g., indicate via one or more measurement messages 210) different CSI measurement configurations for measuring CSI-RSs communicated via SBFD time intervals and non-SBFD time intervals. For example, the network entity may indicate a first measurement configuration associated with SBFD time intervals (e.g., 430 or 435) and a second measurement configuration associated the non-SBFD time intervals 425. Accordingly, the UE 115 may measure CSI-RSs received via a SBFD time interval 430 or 435 in accordance with the first measurement configuration and CSI-RSs received via a non-SBFD time interval 425 in accordance with the second measurement configuration.

In some examples, the first and second measurement configurations may indicate different antenna configurations and/or different antenna port configurations for measuring CSI-RSs. For example, the first measurement configuration may indicate (e.g., via a CSI-RS-ResourceMapping IE) that a first quantity of antenna ports are to be used to receive CSI-RSs via (e.g., during) SBFD time intervals and a second quantity of antenna ports are to be used to receive CSI-RSs via non-SBFD time intervals 425. For instance, first measurement configuration may indicate that the first 16 antenna ports are used for CSI occasions (e.g., durations during which CSI-RSs are communicated) in SBFD time intervals, and the second measurement configuration may indicate that 32 antenna ports are used for CSI occasions in non-SBFD time intervals 425. In some examples, such measurement configurations may support improved CSI-RS reception and measurement if communicating in an FRI frequency range (e.g., 410 MHz-7.125 GHz, a sub-6 GHz range) with split antenna panels.

In some examples, the first and second measurement configurations may indicate different TCI states for measuring CSI-RSs. For example, the first measurement configuration may indicate a first TCI state (e.g., associated with first quasi co location (QCL) information) for CSI occasions in SBFD time intervals, and the second measurement configuration may indicate a second TCI state (e.g., associated with second QCL information) for CSI occasions in non-SBFD time intervals 425. For instance, the network entity 105 may configure two qcl-InfoPeriodicCSI-RSs with a different TCI-StateId in NZP-CSI-RS-Resource IE for SBFD time intervals and non-SBFD time intervals. In some examples, configuring different TCI states may support reduction in self-interference, cross link interference (CLI), clutter, or a combination thereof, such as by indicating the usage of different beams for communicating via SBFD time intervals and non-SBFD time intervals. For example, beams that reduce self-interference, CLI, and/or clutter associated with SBFD communications may be selected and used for CSI occasions in SBFD time intervals.

In some examples, the network entity 105 may configure (e.g., indicate via one or more reporting messages 215) different CSI reporting configurations for reporting CSI associated SBFD time intervals and non-SBFD time intervals. For example, the network entity 105 may indicate a first reporting configuration for CSI associated with the SBFD time intervals and a second reporting configuration for CSI associated with the non-SBFD time intervals 425.

In some cases, the reporting configurations may indicate for the UE 115 to measure and report on CSI-RSs via one type of time intervals and not the other. For example, the first reporting configuration may indicate for the UE 115 to measure CSI-RSs received via the SBFD time intervals and to refrain from measuring CSI-RSs received via the non-SBFD time intervals 425. Additionally, the second reporting configuration may indicate for the UE 115 to refrain from measuring CSI-RSs received via the SBFD time intervals and to measure CSI-RSs received via the non-SBFD time intervals 425. For instance, the first reporting configuration may indicate to only measure periodic, semi-persistent, and aperiodic CSI-RSs on SBFD time intervals, and the second reporting configuration may indicate to only measure periodic, semi-persistent, and aperiodic CSI-RSs on non-SBFD time intervals 425.

In some other examples, the network entity 105 may configure (e.g., indicate via one or more reporting messages 215) a same CSI reporting configuration for reporting CSI associated SBFD time intervals and non-SBFD time intervals. That is, the UE 115 may be configured to report on both non-SBFD and SBFD time intervals, and a report may include one of CSI associated with a SBFD time interval or CSI associated a non-SBFD time interval 425. Here, the network entity 105 may be aware of whether a report is mapped to a CSI occasion in a SBFD time interval or a non-SBFD time interval, such that the network entity 105 may use the report accordingly for different time interval types. Additionally, the UE 115 may be restricted from averaging CSI measurement results associated with different time interval types. For example, the UE 115 may disable averaging first CSI associated with an SBFD time interval and second CSI associated with a non-SBFD time interval 425 based on the UE 115 being configured to report CSI on both types of time intervals, as CSI measurements in different types of time intervals may be different and averaging the measurements may reduce an accuracy of the CSI measurements.

FIG. 5 shows an example of a process flow 500 that supports SBFD CSI-RS communication in accordance with one or more aspects of the present disclosure. In some examples, process flow 500 may implement aspects of the wireless communications systems 100 or 200. For example, the process flow 500 may support CSI measurement and reporting in association with SBFD communications. The process flow 500 may be implemented by a network entity 105-b and a UE 115-c, which may be examples of corresponding devices described herein, including with reference to FIGS. 1 through 4.

In the following description of process flow 500, the operations between the network entity 105-b and the UE 115-c may be performed in a different order than the order shown, or other operations may be added or removed from the process flow 500. For example, some operations may also be left out of process flow 500, or may be performed in different orders or at different times. Further, although some operations or signaling may be shown to occur at different times for discussion purposes, these operations may actually occur at the same time. Additionally, although the network entity 105-b and the UE 115-c are shown performing the operations of process flow 500, some aspects of some operations may also be performed by one or more other wireless or network devices.

At 505, the network entity 105-b may transmit a linkage message to the UE 115-c. The linkage message may indicate a set of linkage identifiers that each indicate a respective linkage of two or more CSI-RS resources across two or more non-contiguous downlink subbands of a SBFD time interval.

At 510, the network entity 105-b may transmit a resource message to the UE 115-c that indicates two or more CSI-RS resources that are linked across the two or more downlink subbands. The resource message may indicate the linkage of the two or more CSI-RS resources via a linkage in a same CSI reporting configuration or via RRC signaling as described with reference to FIG. 3. In some examples, the resource message may indicate a linkage identifier of the set of linkage identifiers indicated by the linkage message.

At 515, the network entity 105-b may transmit two or more CSI-RSs via the two or more CSI-RS resources (e.g., via the two or more downlink subbands). The UE 115-c may receive and measure the two or more CSI-RSs.

At 520, the UE 115-c may transmit a report to the network entity 105-b that is based on the two or more CSI-RSs. For example, the UE 115-c may generate a single measurement metric (e.g., a single L1 metric, single CSI) that is associated with the two or more CSI-RSs based on the CSI-RS resources being linked.

At 525, the network entity 105-b may update a linkage of CSI-RS resources across the two or more downlink subbands. For example, the network entity 105-b may transmit an update message (e.g., via a MAC-CE, via DCI) that updates the linkage from the two or more CSI-RS resources to two or more second CSI-RS resources. In some examples, the update message may update the linkage by indicating a new linkage identifier associated with the two or more second CSI-RS resources or two or more identifiers associated with the two or more second CSI-RS resources.

At 530, the network entity 105-b may transmit two or more second CSI-RSs via the updated CSI-RS resources. For example, the network entity 105-b may transmit the two or more second CSI-RSs via the two or more second CSI-RS resources based on updating the linkage.

At 535, the UE 115-c may transmit a second report to the network entity 105-b that includes a single second measurement metric that is associated with the two or more second CSI-RSs.

FIG. 6 shows an example of a process flow 600 that supports SBFD CSI-RS communication in accordance with one or more aspects of the present disclosure. In some examples, process flow 600 may implement aspects of the wireless communications systems 100 or 200. For example, the process flow 600 may support CSI measurement and reporting in association with SBFD communications. The process flow 600 may be implemented by a network entity 105-c and a UE 115-d, which may be examples of corresponding devices described herein, including with reference to FIGS. 1 through 5.

In the following description of process flow 600, the operations between the network entity 105-c and the UE 115-d may be performed in a different order than the order shown, or other operations may be added or removed from the process flow 600. For example, some operations may also be left out of process flow 600, or may be performed in different orders or at different times. Further, although some operations or signaling may be shown to occur at different times for discussion purposes, these operations may actually occur at the same time. Additionally, although the network entity 105-c and the UE 115-d are shown performing the operations of process flow 600, some aspects of some operations may also be performed by one or more other wireless or network devices.

At 605, the network entity 105-c may transmit one or more measurement messages to the UE 115-d. The one or more measurement messages may indicate a first measurement configuration for CSI measurement associated with a SBFD time interval and a second measurement configuration for CSI measurement associated with a non-SBFD time interval. In some examples, the first and second measurement configurations may indicate respective antenna port quantities, respective antenna configurations, respective TCI states, or a combination thereof, for CSI measurement associated with the respective types of time intervals.

At 610, the network entity 105-c may transmit one or more reporting messages to the UE 115-d. The one or more reporting messages may indicate one or more reporting configurations for reporting CSI associated with a SBFD time interval and CSI associated with a non-SBFD time interval. For example, the one or more reporting messages may indicate a first reporting configuration for reporting CSI generated based on CSI-RSs received via SBFD time intervals and a second reporting configuration for reporting CSI generated based on CSI-RSs received via non-SBFD time intervals. In some examples, the different reporting configurations may indicate different types of CSI (e.g., RI, LI, and so on) to report for the different time intervals, different periodicities at which to report CSI, different types of CSI resources for which to report CSI (e.g., periodic, semi-persistent, aperiodic), among other parameters that may be configured for reporting CSI.

Alternatively, the one or more reporting messages may indicate a same reporting configuration for reporting CSI generated based on CSI-RSs received via SBFD time intervals and CSI generated based on CSI-RSs received via non-SBFD time intervals.

At 615, the UE 115-d may disable CSI averaging across different types of time intervals. For example, if the UE 115-d is configured with a same reporting configuration for reporting CSI for SBFD and non-SBFD time intervals, the UE 115-d may disable the averaging of measurement metrics generated based on CSI-RSs received via SBFD time intervals and measurement metrics generated based on CSI-RSs received via non-SBFD time intervals.

At 620, the network entity 105-c may transmit one or more CSI-RSs to the UE 115-d. The UE 115-d may measure the CSI-RSs in accordance with the first or second measurement configurations (e.g., and the first or second reporting configurations or the same reporting configuration) based on whether the CSI-RSs are transmitted via one or more SBFD time intervals or one or more non-SBFD time intervals.

At 625, the UE 115-d may transmit a report to the network entity 105-c indicating CSI that is based on the one or more CSI-RSs. For example, the UE 115-d may generate the CSI in accordance with the first or second measurement configurations and report the CSI in accordance with the first or second reporting configuration or the same reporting configuration. If the UE 115-d is configured with the same reporting configuration for reporting CSI for SBFD and non-SBFD time intervals, the network entity 105-c may determine whether the report comprises first CSI associated with the one or more SBFD time intervals or second CSI associated with the one or more non-SBFD time intervals based on whether the one or more CSI-RSs are transmitted via the one or more SBFD time interval or the one or more non-SBFD time intervals.

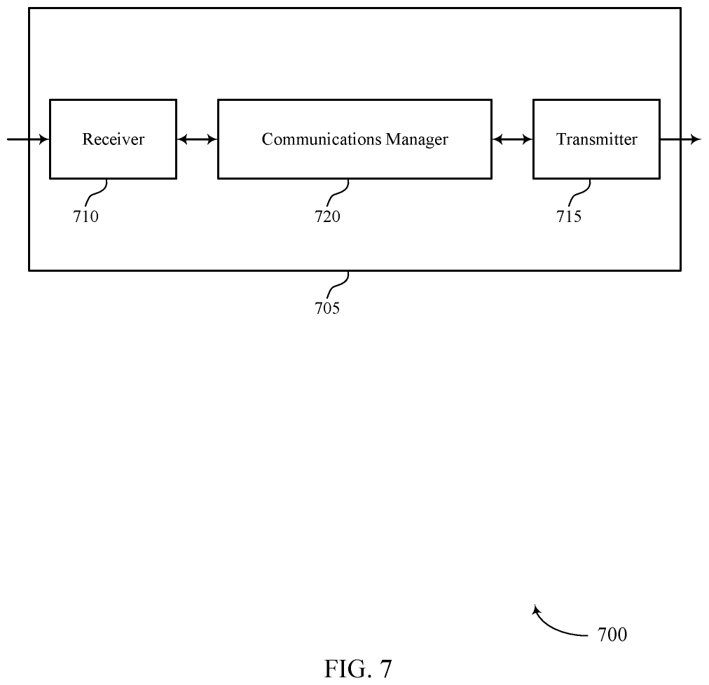

FIG. 7 shows a block diagram 700 of a device 705 that supports SBFD CSI-RS communication in accordance with one or more aspects of the present disclosure. The device 705 may be an example of aspects of a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to SBFD CSI-RS communication). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to SBFD CSI-RS communication). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of SBFD CSI-RS communication as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications at a UE in accordance with examples as disclosed herein. For example, the communications manager 720 is capable of, configured to, or operable to support a means for receiving a control message indicating that two or more CSI-RS resources are linked across two or more downlink subbands, the two or more downlink subbands being non-contiguous in a frequency domain and at least partially overlapping in a time domain. The communications manager 720 is capable of, configured to, or operable to support a means for receiving two or more CSI-RSs via the two or more CSI-RS resources. The communications manager 720 is capable of, configured to, or operable to support a means for transmitting a report based on the two or more CSI-RSs, the report indicating a single measurement metric associated with the two or more CSI-RSs based on the control message indicating that the two or more CSI-RS resources are linked.

Additionally, or alternatively, the communications manager 720 may support wireless communications at a UE in accordance with examples as disclosed herein. For example, the communications manager 720 is capable of, configured to, or operable to support a means for receiving at least one control message indicating a first measurement configuration for CSI measurement via a SBFD time interval and a second measurement configuration for CSI measurement via a non-SBFD time interval, the SBFD time interval including two or more downlink subbands that are non-contiguous in a frequency domain and at least partially overlap in a time domain. The communications manager 720 is capable of, configured to, or operable to support a means for receiving one or more CSI-RSs via the SBFD time interval in accordance with the first measurement configuration or via the non-SBFD time interval in accordance with the second measurement configuration. The communications manager 720 is capable of, configured to, or operable to support a means for transmitting a report indicating CSI that is based on the one or more CSI-RSs.

By including or configuring the communications manager 720 in accordance with examples as described herein, the device 705 (e.g., a processor controlling or otherwise coupled with the receiver 710, the transmitter 715, the communications manager 720, or a combination thereof) may support techniques for more efficient utilization of communication resources, such as by supporting CSI measurement and reporting in association with flexible duplexing (e.g., SBFD configurations), among other benefits.

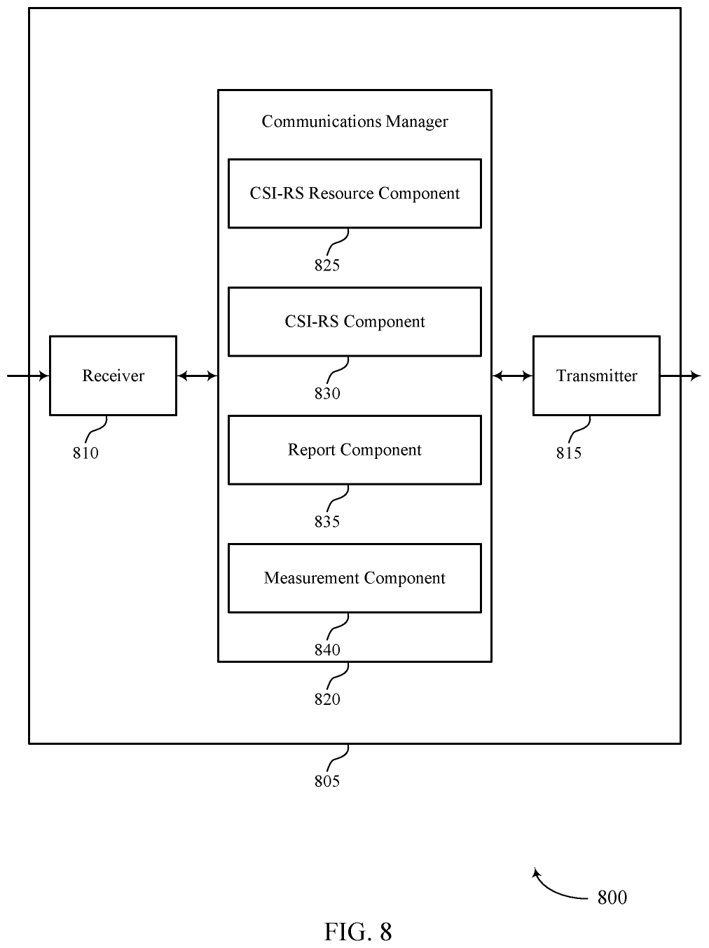

FIG. 8 shows a block diagram 800 of a device 805 that supports SBFD CSI-RS communication in accordance with one or more aspects of the present disclosure. The device 805 may be an example of aspects of a device 705 or a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to SBFD CSI-RS communication). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to SBFD CSI-RS communication). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of SBFD CSI-RS communication as described herein. For example, the communications manager 820 may include a CSI-RS resource component 825, a CSI-RS component 830, a report component 835, a measurement component 840, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications at a UE in accordance with examples as disclosed herein. The CSI-RS resource component 825 is capable of, configured to, or operable to support a means for receiving a control message indicating that two or more CSI-RS resources are linked across two or more downlink subbands, the two or more downlink subbands being non-contiguous in a frequency domain and at least partially overlapping in a time domain. The CSI-RS component 830 is capable of, configured to, or operable to support a means for receiving two or more CSI-RSs via the two or more CSI-RS resources. The report component 835 is capable of, configured to, or operable to support a means for transmitting a report based on the two or more CSI-RSs, the report indicating a single measurement metric associated with the two or more CSI-RSs based on the control message indicating that the two or more CSI-RS resources are linked.

Additionally, or alternatively, the communications manager 820 may support wireless communications at a UE in accordance with examples as disclosed herein. The measurement component 840 is capable of, configured to, or operable to support a means for receiving at least one control message indicating a first measurement configuration for CSI measurement via a SBFD time interval and a second measurement configuration for CSI measurement via a non-SBFD time interval, the SBFD time interval including two or more downlink subbands that are non-contiguous in a frequency domain and at least partially overlap in a time domain. The CSI-RS component 830 is capable of, configured to, or operable to support a means for receiving one or more CSI-RSs via the SBFD time interval in accordance with the first measurement configuration or via the non-SBFD time interval in accordance with the second measurement configuration. The report component 835 is capable of, configured to, or operable to support a means for transmitting a report indicating CSI that is based on the one or more CSI-RSs.

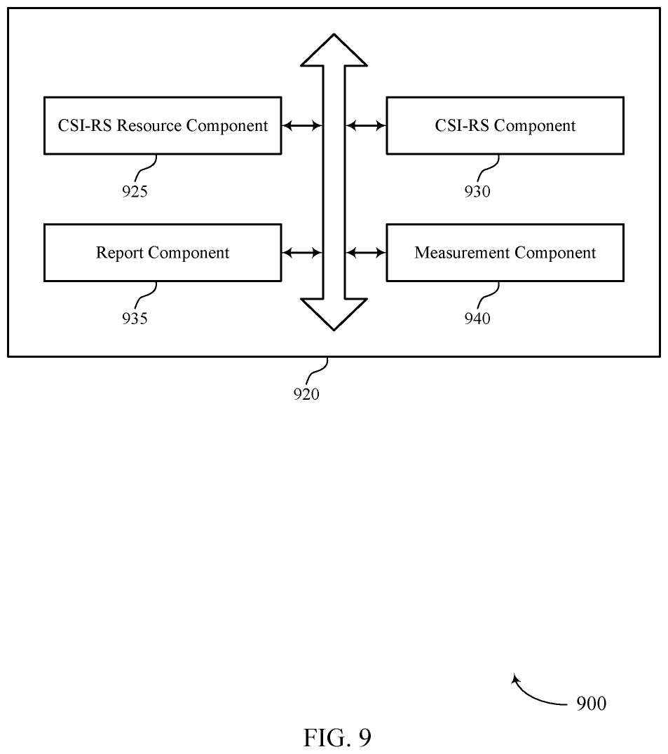

FIG. 9 shows a block diagram 900 of a communications manager 920 that supports SBFD CSI-RS communication in accordance with one or more aspects of the present disclosure. The communications manager 920 may be an example of aspects of a communications manager 720, a communications manager 820, or both, as described herein. The communications manager 920, or various components thereof, may be an example of means for performing various aspects of SBFD CSI-RS communication as described herein. For example, the communications manager 920 may include a CSI-RS resource component 925, a CSI-RS component 930, a report component 935, a measurement component 940, or any combination thereof. Each of these components may communicate, directly or indirectly, with one another (e.g., via one or more buses).

The communications manager 920 may support wireless communications at a UE in accordance with examples as disclosed herein. The CSI-RS resource component 925 is capable of, configured to, or operable to support a means for receiving a control message indicating that two or more CSI-RS resources are linked across two or more downlink subbands, the two or more downlink subbands being non-contiguous in a frequency domain and at least partially overlapping in a time domain. The CSI-RS component 930 is capable of, configured to, or operable to support a means for receiving two or more CSI-RSs via the two or more CSI-RS resources. The report component 935 is capable of, configured to, or operable to support a means for transmitting a report based on the two or more CSI-RSs, the report indicating a single measurement metric associated with the two or more CSI-RSs based on the control message indicating that the two or more CSI-RS resources are linked.

In some examples, the two or more CSI-RS resources are linked in a same CSI reporting configuration indicated by the control message.

In some examples, the control message indicates that the two or more CSI-RS resources are included in a same CMR set or a same IMR set associated with the two or more downlink subbands.

In some examples, the control message indicates that respective CSI-RS resources of the two or more CSI-RS resources associated with respective resource identifiers are included in respective CMRs of a same CMR set or respective IMRs of a same IMR set associated with the two or more downlink subbands. In some examples, the report indicates the single measurement metric associated with the two or more CSI-RSs based on the respective CMRs being of the same CMR set or the respective IMRs being of the same IMR set.

In some examples, the control message includes a flag indicating that the respective CMRs or the respective IMRs are linked across the two or more downlink subbands.

In some examples, the control message indicates two CMRs and a single IMR. In some examples, the single measurement metric corresponds to an average of respective measurement metrics associated with the two CMRs divided by a measurement metric associated with the single IMR.

In some examples, the control message indicates two CMRs and two IMRs. In some examples, the single measurement metric corresponds to a first average of respective measurement metrics associated with the two CMRs divided by a second average of respective measurement metrics associated with the two IMRs.

In some examples, the control message indicates the two CMRs and two IMRs in accordance with a rule that the control message indicates a same quantity of CMRs and IMRs as downlink subbands across which CSI-RS resources are linked.

In some examples, the control message includes an IE associated with a first CSI-RS resource of the two or more CSI-RS resources, the IE including an identifier associated with a second CSI-RS resource of the two or more CSI-RS resources. In some examples, the first CSI-RS resource and the second CSI-RS resource are linked across the two or more downlink subbands based on the IE associated with the first CSI-RS resource including the identifier associated with the second CSI-RS resource.

In some examples, the control message includes a linkage identifier associated with the two or more CSI-RS resources that indicates the two or more CSI-RS resources are linked.

In some examples, the CSI-RS resource component 925 is capable of, configured to, or operable to support a means for receiving a second control message including an IE indicating a set of linkage identifiers including the linkage identifier, each linkage identifier associated with a respective set of two or more CSI-RS resources that are linked, where the control message includes the linkage identifier from the set of linkage identifiers indicated by the second control message.

In some examples, the CSI-RS resource component 925 is capable of, configured to, or operable to support a means for receiving a second control message that updates a linkage of CSI-RSs across the two or more downlink subbands to two or more second CSI-RS resources based on indicating a second linkage identifier associated with the two or more second CSI-RS resources. In some examples, the CSI-RS component 930 is capable of, configured to, or operable to support a means for receiving two or more second CSI-RSs via the two or more second CSI-RS resources based on the second control message. In some examples, the report component 935 is capable of, configured to, or operable to support a means for transmitting a second report based on the two or more second CSI-RSs, the second report indicating a single second measurement metric associated with the two or more second CSI-RSs. In some examples, the second control message includes a MAC-CE or DCI.

In some examples, the CSI-RS resource component 925 is capable of, configured to, or operable to support a means for receiving a second control message that updates a linkage of CSI-RSs across the two or more downlink subbands to two or more second CSI-RS resources based on indicating respective CSI-RS resource identifiers associated with the two or more second CSI-RS resources. In some examples, the CSI-RS component 930 is capable of, configured to, or operable to support a means for receiving two or more second CSI-RSs via the two or more second CSI-RS resources based on the second control message. In some examples, the report component 935 is capable of, configured to, or operable to support a means for transmitting a second report based on the two or more second CSI-RSs, the second report indicating a single second measurement metric associated with the two or more second CSI-RSs.

In some examples, the CSI-RS resource component 925 is capable of, configured to, or operable to support a means for removing a linkage of a first CSI-RS resource and a second CSI-RS resource of the two or more CSI-RS resources based on a CSI-RS resource identifier associated with the first CSI-RS resource being indicated by the second control message.

In some examples, the second control message includes a MAC-CE or DCI.

In some examples, one or more uplink subbands that overlap in a SBFD symbol with the two or more downlink subbands in the time domain are located between respective downlink subbands of the two or more downlink subbands in the frequency domain.

Additionally, or alternatively, the communications manager 920 may support wireless communications at a UE in accordance with examples as disclosed herein. The measurement component 940 is capable of, configured to, or operable to support a means for receiving at least one control message indicating a first measurement configuration for CSI measurement via a SBFD time interval and a second measurement configuration for CSI measurement via a non-SBFD time interval, the SBFD time interval including two or more downlink subbands that are non-contiguous in a frequency domain and at least partially overlap in a time domain. In some examples, the CSI-RS component 930 is capable of, configured to, or operable to support a means for receiving one or more CSI-RSs via the SBFD time interval in accordance with the first measurement configuration or via the non-SBFD time interval in accordance with the second measurement configuration. In some examples, the report component 935 is capable of, configured to, or operable to support a means for transmitting a report indicating CSI that is based on the one or more CSI-RSs.

In some examples, the first measurement configuration indicates a first quantity of antenna ports or a first antenna configuration to use for CSI measurement via the SBFD time interval. In some examples, the second measurement configuration indicates a second quantity of antenna ports or a second antenna configuration to use for CSI measurement via the non-SBFD time interval.

In some examples, the first measurement configuration indicates a first TCI state associated with CSI measurement via the SBFD time interval. In some examples, the second measurement configuration indicates a second TCI state associated with CSI measurement via the non-SBFD time interval.

In some examples, the first TCI state is associated with first QCL information associated with the SBFD time interval. In some examples, the second TCI state is associated with second QCL information associated with the non-SBFD time interval.

In some examples, the report component 935 is capable of, configured to, or operable to support a means for receiving at least one second control message indicating a first reporting configuration for CSI associated with the SBFD time interval and a second reporting configuration for CSI associated with the non-SBFD time interval, where the report is transmitted in accordance with the first reporting configuration or the second reporting configuration.

In some examples, the first reporting configuration indicates for the UE to measure CSI-RSs received via the SBFD time interval and to refrain from measuring CSI-RSs received via the non-SBFD time interval. In some examples, the second reporting configuration indicates for the UE to refrain from measuring CSI-RSs received via the SBFD time interval and to measure CSI-RSs received via the non-SBFD time interval. In some examples, the one or more CSI-RSs are measured in accordance with the first reporting configuration or the second reporting configuration.

In some examples, the report component 935 is capable of, configured to, or operable to support a means for receiving at least one second control message indicating a reporting configuration for CSI associated with the SBFD time interval and the non-SBFD time interval, where the CSI indicated by the report includes first CSI associated with the SBFD time interval or second CSI associated with the non-SBFD time interval based on the reporting configuration being for CSI associated with the SBFD time interval and the non-SBFD time interval.

In some examples, the measurement component 940 is capable of, configured to, or operable to support a means for disabling, based on the reporting configuration being for CSI associated with the SBFD time interval and the non-SBFD time interval, averaging the first CSI associated with the SBFD time interval and the second CSI associated with the non-SBFD time interval.

In some examples, one or more uplink subbands that overlap in a SBFD symbol with the two or more downlink subbands in the time domain are located between respective downlink subbands of the two or more downlink subbands in the frequency domain.

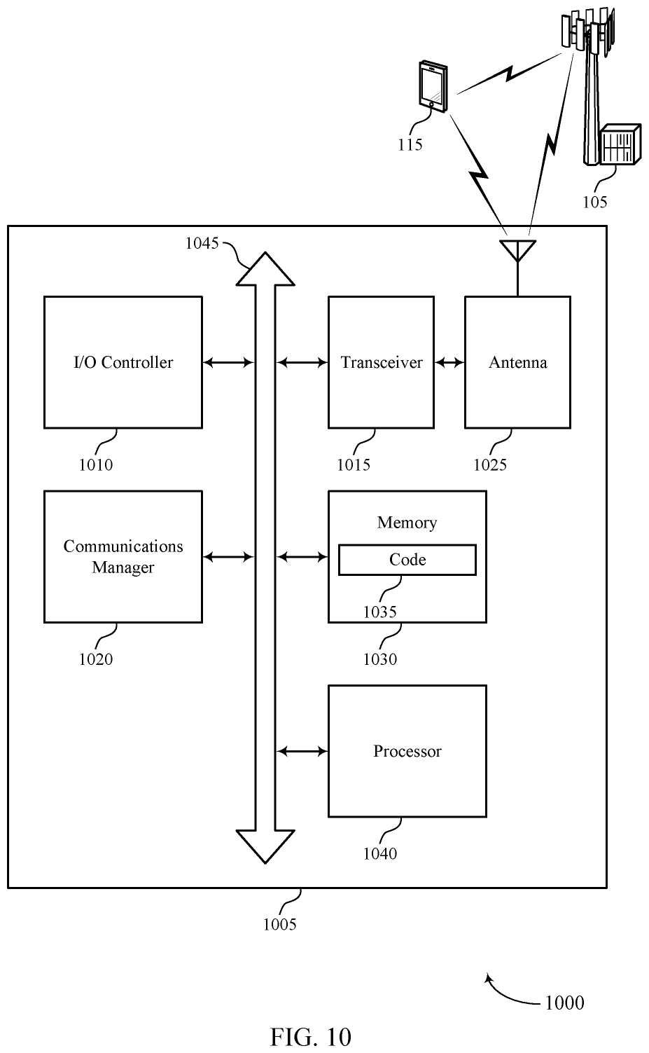

FIG. 10 shows a diagram of a system 1000 including a device 1005 that supports SBFD CSI-RS communication in accordance with one or more aspects of the present disclosure. The device 1005 may be an example of or include the components of a device 705, a device 805, or a UE 115 as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting SBFD CSI-RS communication). For example, the device 1005 or a component of the device 1005 may include a processor 1040 and memory 1030 coupled with or to the processor 1040, the processor 1040 and memory 1030 configured to perform various functions described herein.

The communications manager 1020 may support wireless communications at a UE in accordance with examples as disclosed herein. For example, the communications manager 1020 is capable of, configured to, or operable to support a means for receiving a control message indicating that two or more CSI-RS resources are linked across two or more downlink subbands, the two or more downlink subbands being non-contiguous in a frequency domain and at least partially overlapping in a time domain. The communications manager 1020 is capable of, configured to, or operable to support a means for receiving two or more CSI-RSs via the two or more CSI-RS resources. The communications manager 1020 is capable of, configured to, or operable to support a means for transmitting a report based on the two or more CSI-RSs, the report indicating a single measurement metric associated with the two or more CSI-RSs based on the control message indicating that the two or more CSI-RS resources are linked.

Additionally, or alternatively, the communications manager 1020 may support wireless communications at a UE in accordance with examples as disclosed herein. For example, the communications manager 1020 is capable of, configured to, or operable to support a means for receiving at least one control message indicating a first measurement configuration for CSI measurement via a SBFD time interval and a second measurement configuration for CSI measurement via a non-SBFD time interval, the SBFD time interval including two or more downlink subbands that are non-contiguous in a frequency domain and at least partially overlap in a time domain. The communications manager 1020 is capable of, configured to, or operable to support a means for receiving one or more CSI-RSs via the SBFD time interval in accordance with the first measurement configuration or via the non-SBFD time interval in accordance with the second measurement configuration. The communications manager 1020 is capable of, configured to, or operable to support a means for transmitting a report indicating CSI that is based on the one or more CSI-RSs.

By including or configuring the communications manager 1020 in accordance with examples as described herein, the device 1005 may support techniques for CSI measurement and reporting in association with flexible duplexing (e.g., SBFD configurations), which may support reduced latency, higher data rates, improved coverage, increased spectral efficiency, increased capacity, more efficient utilization of communication resources, and improved coordination between devices, among other benefits.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of SBFD CSI-RS communication as described herein, or the processor 1040 and the memory 1030 may be otherwise configured to perform or support such operations.

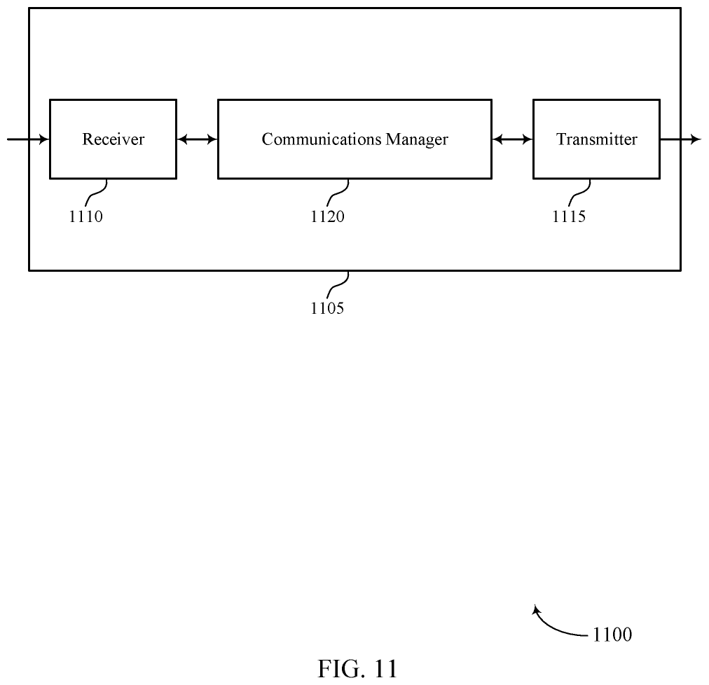

FIG. 11 shows a block diagram 1100 of a device 1105 that supports SBFD CSI-RS communication in accordance with one or more aspects of the present disclosure. The device 1105 may be an example of aspects of a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations thereof or various components thereof may be examples of means for performing various aspects of SBFD CSI-RS communication as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1120, the receiver 1110, the transmitter 1115, or various combinations or components thereof may be implemented in code (e.g., as communications management software or firmware) executed by a processor. If implemented in code executed by a processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications at a network entity in accordance with examples as disclosed herein. For example, the communications manager 1120 is capable of, configured to, or operable to support a means for transmitting a control message indicating that two or more CSI-RS resources are linked across two or more downlink subbands, the two or more downlink subbands being non-contiguous in a frequency domain and at least partially overlapping in a time domain. The communications manager 1120 is capable of, configured to, or operable to support a means for transmitting two or more CSI-RSs via the two or more CSI-RS resources. The communications manager 1120 is capable of, configured to, or operable to support a means for receiving a report based on the two or more CSI-RSs, the report indicating a single measurement metric associated with the two or more CSI-RSs based on the control message indicating that the two or more CSI-RS resources are linked.

Additionally, or alternatively, the communications manager 1120 may support wireless communications at a network entity in accordance with examples as disclosed herein. For example, the communications manager 1120 is capable of, configured to, or operable to support a means for transmitting at least one control message indicating a first measurement configuration for CSI measurement via a SBFD time interval and a second measurement configuration for CSI measurement via a non-SBFD time interval, the SBFD time interval including two or more downlink subbands that are non-contiguous in a frequency domain and at least partially overlap in a time domain. The communications manager 1120 is capable of, configured to, or operable to support a means for transmitting one or more CSI-RSs via the SBFD time interval or via the non-SBFD time interval. The communications manager 1120 is capable of, configured to, or operable to support a means for receiving, in accordance with the first measurement configuration or the second measurement configuration, a report indicating CSI that is based on the one or more CSI-RSs.

By including or configuring the communications manager 1120 in accordance with examples as described herein, the device 1105 (e.g., a processor controlling or otherwise coupled with the receiver 1110, the transmitter 1115, the communications manager 1120, or a combination thereof) may support techniques for more efficient utilization of communication resources, such as by supporting CSI measurement and reporting in association with flexible duplexing (e.g., SBFD configurations), among other benefits.

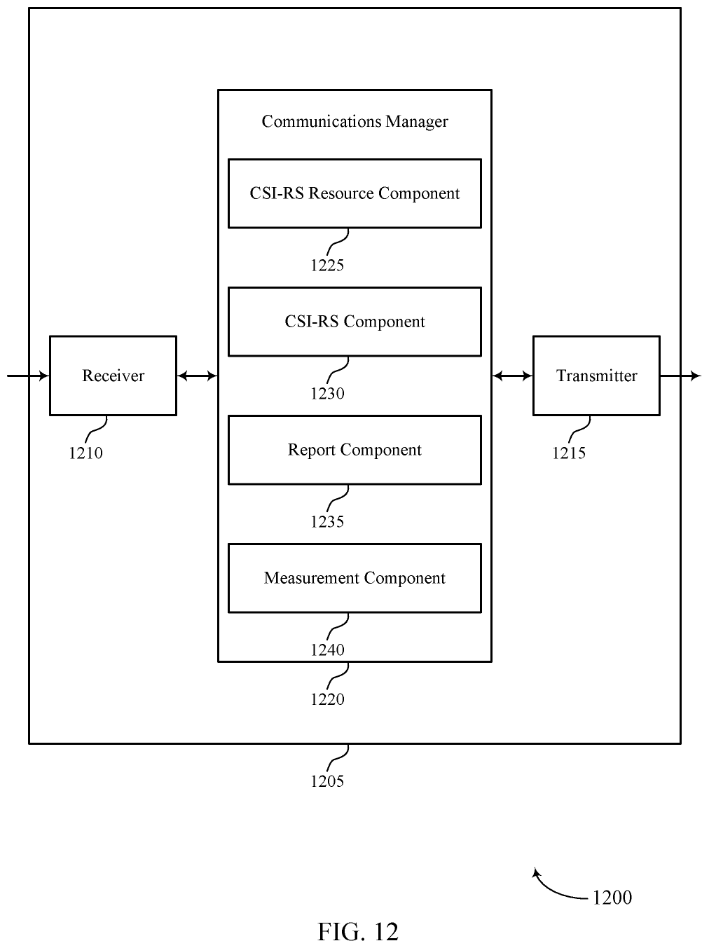

FIG. 12 shows a block diagram 1200 of a device 1205 that supports SBFD CSI-RS communication in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of SBFD CSI-RS communication as described herein. For example, the communications manager 1220 may include a CSI-RS resource component 1225, a CSI-RS component 1230, a report component 1235, a measurement component 1240, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications at a network entity in accordance with examples as disclosed herein. The CSI-RS resource component 1225 is capable of, configured to, or operable to support a means for transmitting a control message indicating that two or more CSI-RS resources are linked across two or more downlink subbands, the two or more downlink subbands being non-contiguous in a frequency domain and at least partially overlapping in a time domain. The CSI-RS component 1230 is capable of, configured to, or operable to support a means for transmitting two or more CSI-RSs via the two or more CSI-RS resources. The report component 1235 is capable of, configured to, or operable to support a means for receiving a report based on the two or more CSI-RSs, the report indicating a single measurement metric associated with the two or more CSI-RSs based on the control message indicating that the two or more CSI-RS resources are linked.

Additionally, or alternatively, the communications manager 1220 may support wireless communications at a network entity in accordance with examples as disclosed herein. The measurement component 1240 is capable of, configured to, or operable to support a means for transmitting at least one control message indicating a first measurement configuration for CSI measurement via a SBFD time interval and a second measurement configuration for CSI measurement via a non-SBFD time interval, the SBFD time interval including two or more downlink subbands that are non-contiguous in a frequency domain and at least partially overlap in a time domain. The CSI-RS component 1230 is capable of, configured to, or operable to support a means for transmitting one or more CSI-RSs via the SBFD time interval or via the non-SBFD time interval. The report component 1235 is capable of, configured to, or operable to support a means for receiving, in accordance with the first measurement configuration or the second measurement configuration, a report indicating CSI that is based on the one or more CSI-RSs.

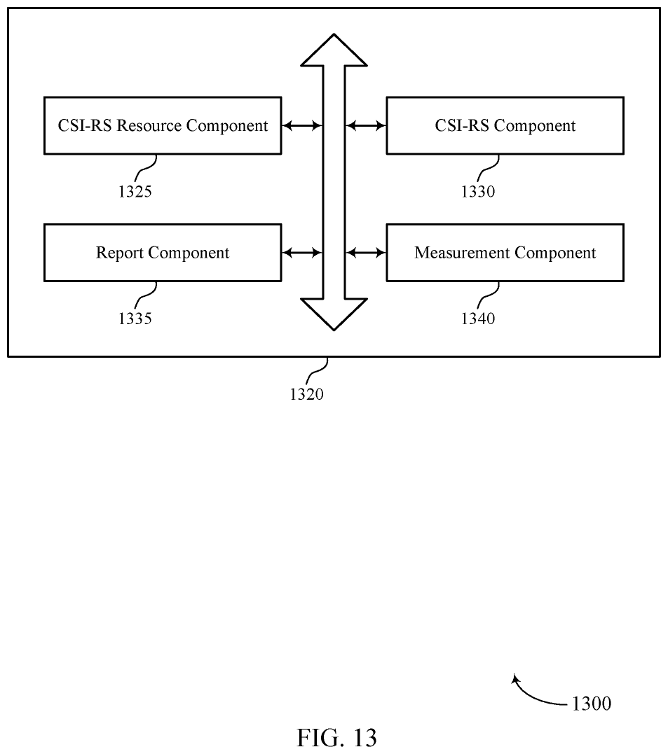

FIG. 13 shows a block diagram 1300 of a communications manager 1320 that supports SBFD CSI-RS communication in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of SBFD CSI-RS communication as described herein. For example, the communications manager 1320 may include a CSI-RS resource component 1325, a CSI-RS component 1330, a report component 1335, a measurement component 1340, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communications at a network entity in accordance with examples as disclosed herein. The CSI-RS resource component 1325 is capable of, configured to, or operable to support a means for transmitting a control message indicating that two or more CSI-RS resources are linked across two or more downlink subbands, the two or more downlink subbands being non-contiguous in a frequency domain and at least partially overlapping in a time domain. The CSI-RS component 1330 is capable of, configured to, or operable to support a means for transmitting two or more CSI-RSs via the two or more CSI-RS resources. The report component 1335 is capable of, configured to, or operable to support a means for receiving a report based on the two or more CSI-RSs, the report indicating a single measurement metric associated with the two or more CSI-RSs based on the control message indicating that the two or more CSI-RS resources are linked.

In some examples, the two or more CSI-RS resources are linked in a same CSI reporting configuration indicated by the control message.

In some examples, the control message indicates that the two or more CSI-RS resources are included in a same CMR set or a same IMR set associated with the two or more downlink subbands.

In some examples, the control message indicates that respective CSI-RS resources of the two or more CSI-RS resources associated with respective resource identifiers are included in respective CMRs of a same CMR set or respective IMRs of a same IMR set associated with the two or more downlink subbands. In some examples, the report indicates the single measurement metric associated with the two or more CSI-RSs based on the respective CMRs being of the same CMR set or the respective IMRs being of the same IMR set.

In some examples, the control message includes a flag indicating that the respective CMRs or the respective IMRs are linked across the two or more downlink subbands.

In some examples, the control message indicates two CMRs and a single IMR. In some examples, the single measurement metric corresponds to an average of respective measurement metrics associated with the two CMRs divided by a measurement metric associated with the single IMR.

In some examples, the control message indicates two CMRs and two IMRs. In some examples, the single measurement metric corresponds to a first average of respective measurement metrics associated with the two CMRs divided by a second average of respective measurement metrics associated with the two IMRs.

In some examples, the control message indicates the two CMRs and two IMRs in accordance with a rule that the control message indicates a same quantity of CMRs and IMRs as downlink subbands across which CSI-RS resources are linked.

In some examples, the control message includes an IE associated with a first CSI-RS resource of the two or more CSI-RS resources, the IE including an identifier associated with a second CSI-RS resource of the two or more CSI-RS resources. In some examples, the first CSI-RS resource and the second CSI-RS resource are linked across the two or more downlink subbands based on the IE associated with the first CSI-RS resource including the identifier associated with the second CSI-RS resource.

In some examples, the control message includes a linkage identifier associated with the two or more CSI-RS resources that indicates the two or more CSI-RS resources are linked.

In some examples, the CSI-RS resource component 1325 is capable of, configured to, or operable to support a means for transmitting a second control message including an IE indicating a set of linkage identifiers including the linkage identifier, each linkage identifier associated with a respective set of two or more CSI-RS resources that are linked, where the control message includes the linkage identifier from the set of linkage identifiers indicated by the second control message.

In some examples, the CSI-RS resource component 1325 is capable of, configured to, or operable to support a means for transmitting a second control message that updates a linkage of CSI-RSs across the two or more downlink subbands to two or more second CSI-RS resources based on indicating a second linkage identifier associated with the two or more second CSI-RS resources. In some examples, the CSI-RS component 1330 is capable of, configured to, or operable to support a means for transmitting two or more second CSI-RSs via the two or more second CSI-RS resources based on the second control message. In some examples, the report component 1335 is capable of, configured to, or operable to support a means for receiving a second report based on the two or more second CSI-RSs, the second report indicating a single second measurement metric associated with the two or more second CSI-RSs.

In some examples, the second control message includes a MAC-CE or DCI.

In some examples, the CSI-RS resource component 1325 is capable of, configured to, or operable to support a means for transmitting a second control message that updates a linkage of CSI-RSs across the two or more downlink subbands to two or more second CSI-RS resources based on indicating respective CSI-RS resource identifiers associated with the two or more second CSI-RS resources. In some examples, the CSI-RS component 1330 is capable of, configured to, or operable to support a means for transmitting two or more second CSI-RSs via the two or more second CSI-RS resources based on the second control message. In some examples, the report component 1335 is capable of, configured to, or operable to support a means for receiving a second report based on the two or more second CSI-RSs, the second report indicating a single second measurement metric associated with the two or more second CSI-RSs.

In some examples, the CSI-RS resource component 1325 is capable of, configured to, or operable to support a means for removing a linkage of a first CSI-RS resource and a second CSI-RS resource of the two or more CSI-RS resources based on a CSI-RS resource identifier associated with the first CSI-RS resource being indicated by the second control message.

In some examples, the second control message includes a MAC-CE or DCI.

In some examples, one or more uplink subbands that overlap in a SBFD symbol with the two or more downlink subbands in the time domain are located between respective downlink subbands of the two or more downlink subbands in the frequency domain.

Additionally, or alternatively, the communications manager 1320 may support wireless communications at a network entity in accordance with examples as disclosed herein. The measurement component 1340 is capable of, configured to, or operable to support a means for transmitting at least one control message indicating a first measurement configuration for CSI measurement via a SBFD time interval and a second measurement configuration for CSI measurement via a non-SBFD time interval, the SBFD time interval including two or more downlink subbands that are non-contiguous in a frequency domain and at least partially overlap in a time domain. In some examples, the CSI-RS component 1330 is capable of, configured to, or operable to support a means for transmitting one or more CSI-RSs via the SBFD time interval or via the non-SBFD time interval. In some examples, the report component 1335 is capable of, configured to, or operable to support a means for receiving, in accordance with the first measurement configuration or the second measurement configuration, a report indicating CSI that is based on the one or more CSI-RSs.

In some examples, the first measurement configuration indicates a first quantity of antenna ports or a first antenna configuration to use for CSI measurement via the SBFD time interval. In some examples, the second measurement configuration indicates a second quantity of antenna ports or a second antenna configuration to use for CSI measurement via the non-SBFD time interval.

In some examples, the first measurement configuration indicates a first TCI state associated with CSI measurement via the SBFD time interval. In some examples, the second measurement configuration indicates a second TCI state associated with CSI measurement via the non-SBFD time interval.

In some examples, the first TCI state is associated with first QCL information associated with the SBFD time interval. In some examples, the second TCI state is associated with second QCL information associated with the non-SBFD time interval.

In some examples, the report component 1335 is capable of, configured to, or operable to support a means for transmitting at least one second control message indicating a first reporting configuration for CSI associated with the SBFD time interval and a second reporting configuration for CSI associated with the non-SBFD time interval, where the report is received in accordance with the first reporting configuration or the second reporting configuration.

In some examples, the first reporting configuration indicates for measurement of CSI-RSs transmitted via the SBFD time interval and lack of measurement of CSI-RSs transmitted via the non-SBFD time interval. In some examples, the second reporting configuration indicates for measurement of CSI-RSs transmitted via the SBFD time interval and lack of measurement of CSI-RSs transmitted via the non-SBFD time interval.

In some examples, the report component 1335 is capable of, configured to, or operable to support a means for transmitting at least one second control message indicating a reporting configuration for CSI associated with the SBFD time interval and the non-SBFD time interval, where the CSI indicated by the report includes first CSI associated with the SBFD time interval or second CSI associated with the non-SBFD time interval based on the reporting configuration being for CSI associated with the SBFD time interval and the non-SBFD time interval.

In some examples, the report component 1335 is capable of, configured to, or operable to support a means for determining whether the report includes the first CSI or the second CSI based on whether the one or more CSI-RSs are transmitted via the SBFD time interval or the non-SBFD time interval.

In some examples, one or more uplink subbands that overlap in a SBFD symbol with the two or more downlink subbands in the time domain are located between respective downlink subbands of the two or more downlink subbands in the frequency domain.

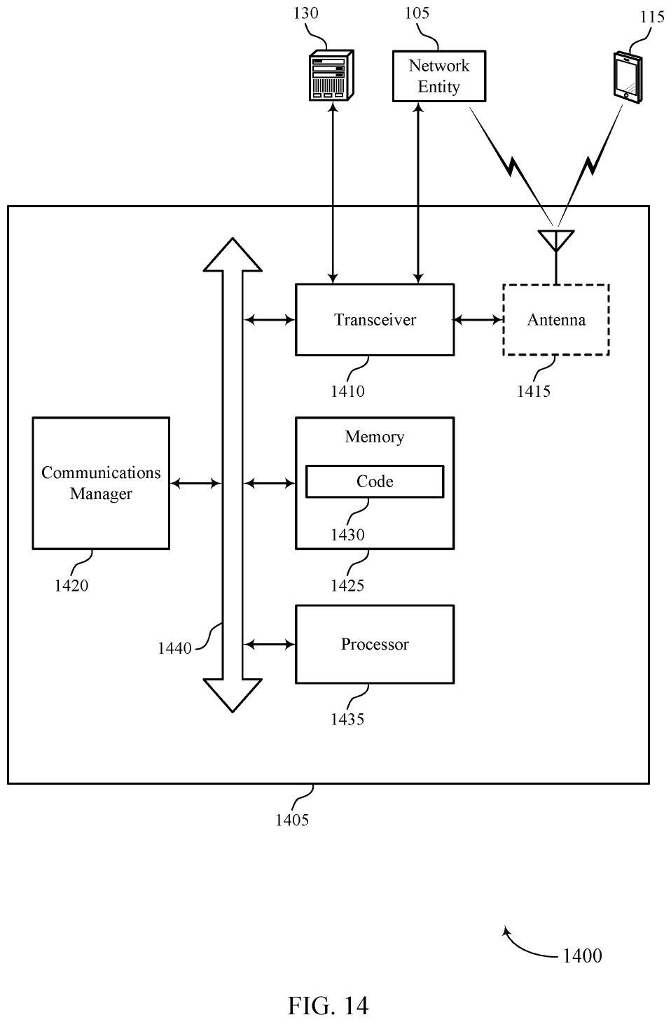

FIG. 14 shows a diagram of a system 1400 including a device 1405 that supports SBFD CSI-RS communication in accordance with one or more aspects of the present disclosure. The device 1405 may be an example of or include the components of a device 1105, a device 1205, or a network entity 105 as described herein. The device 1405 may communicate with one or more network entities 105, one or more UEs 115, or any combination thereof, which may include communications over one or more wired interfaces, over one or more wireless interfaces, or any combination thereof. The device 1405 may include components that support outputting and obtaining communications, such as a communications manager 1420, a transceiver 1410, an antenna 1415, a memory 1425, code 1430, and a processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or memory components (for example, the processor 1435, or the memory 1425, or both), may be included in a chip or chip assembly that is installed in the device 1405. In some examples, the transceiver may be operable to support communications via one or more communications links (e.g., a communication link 125, a backhaul communication link 120, a midhaul communication link 162, a fronthaul communication link 168).

The memory 1425 may include RAM and ROM. The memory 1425 may store computer-readable, computer-executable code 1430 including instructions that, when executed by the processor 1435, cause the device 1405 to perform various functions described herein. The code 1430 may be stored in a non-transitory computer-readable medium such as system memory or another type of memory. In some cases, the code 1430 may not be directly executable by the processor 1435 but may cause a computer (e.g., when compiled and executed) to perform functions described herein. In some cases, the memory 1425 may contain, among other things, a BIOS which may control basic hardware or software operation such as the interaction with peripheral components or devices.

The processor 1435 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1435 may be configured to operate a memory array using a memory controller. In some other cases, a memory controller may be integrated into the processor 1435. The processor 1435 may be configured to execute computer-readable instructions stored in a memory (e.g., the memory 1425) to cause the device 1405 to perform various functions (e.g., functions or tasks supporting SBFD CSI-RS communication). For example, the device 1405 or a component of the device 1405 may include a processor 1435 and memory 1425 coupled with the processor 1435, the processor 1435 and memory 1425 configured to perform various functions described herein. The processor 1435 may be an example of a cloud-computing platform (e.g., one or more physical nodes and supporting software such as operating systems, virtual machines, or container instances) that may host the functions (e.g., by executing code 1430) to perform the functions of the device 1405. The processor 1435 may be any one or more suitable processors capable of executing scripts or instructions of one or more software programs stored in the device 1405 (such as within the memory 1425). In some implementations, the processor 1435 may be a component of a processing system. A processing system may generally refer to a system or series of machines or components that receives inputs and processes the inputs to produce a set of outputs (which may be passed to other systems or components of, for example, the device 1405). For example, a processing system of the device 1405 may refer to a system including the various other components or subcomponents of the device 1405, such as the processor 1435, or the transceiver 1410, or the communications manager 1420, or other components or combinations of components of the device 1405. The processing system of the device 1405 may interface with other components of the device 1405, and may process information received from other components (such as inputs or signals) or output information to other components. For example, a chip or modem of the device 1405 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1405 may transmit information output from the chip or modem. Additionally, or alternatively, in some implementations, the one or more interfaces may refer to an interface between the processing system of the chip or modem and a receiver, such that the device 1405 may obtain information or signal inputs, and the information may be passed to the processing system. A person having ordinary skill in the art will readily recognize that a first interface also may obtain information or signal inputs, and a second interface also may output information or signal outputs.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the memory 1425, the code 1430, and the processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with other network entities 105, and may include a controller or scheduler for controlling communications with UEs 115 in cooperation with other network entities 105. In some examples, the communications manager 1420 may support an X2 interface within an LTE/LTE-A wireless communications network technology to provide communication between network entities 105.

The communications manager 1420 may support wireless communications at a network entity in accordance with examples as disclosed herein. For example, the communications manager 1420 is capable of, configured to, or operable to support a means for transmitting a control message indicating that two or more CSI-RS resources are linked across two or more downlink subbands, the two or more downlink subbands being non-contiguous in a frequency domain and at least partially overlapping in a time domain. The communications manager 1420 is capable of, configured to, or operable to support a means for transmitting two or more CSI-RSs via the two or more CSI-RS resources. The communications manager 1420 is capable of, configured to, or operable to support a means for receiving a report based on the two or more CSI-RSs, the report indicating a single measurement metric associated with the two or more CSI-RSs based on the control message indicating that the two or more CSI-RS resources are linked.

Additionally, or alternatively, the communications manager 1420 may support wireless communications at a network entity in accordance with examples as disclosed herein. For example, the communications manager 1420 is capable of, configured to, or operable to support a means for transmitting at least one control message indicating a first measurement configuration for CSI measurement via a SBFD time interval and a second measurement configuration for CSI measurement via a non-SBFD time interval, the SBFD time interval including two or more downlink subbands that are non-contiguous in a frequency domain and at least partially overlap in a time domain. The communications manager 1420 is capable of, configured to, or operable to support a means for transmitting one or more CSI-RSs via the SBFD time interval or via the non-SBFD time interval. The communications manager 1420 is capable of, configured to, or operable to support a means for receiving, in accordance with the first measurement configuration or the second measurement configuration, a report indicating CSI that is based on the one or more CSI-RSs.

By including or configuring the communications manager 1420 in accordance with examples as described herein, the device 1405 may support techniques for CSI measurement and reporting in association with flexible duplexing (e.g., SBFD configurations), which may support reduced latency, higher data rates, improved coverage, increased spectral efficiency, increased capacity, more efficient utilization of communication resources, and improved coordination between devices, among other benefits.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, the processor 1435, the memory 1425, the code 1430, or any combination thereof. For example, the code 1430 may include instructions executable by the processor 1435 to cause the device 1405 to perform various aspects of SBFD CSI-RS communication as described herein, or the processor 1435 and the memory 1425 may be otherwise configured to perform or support such operations.

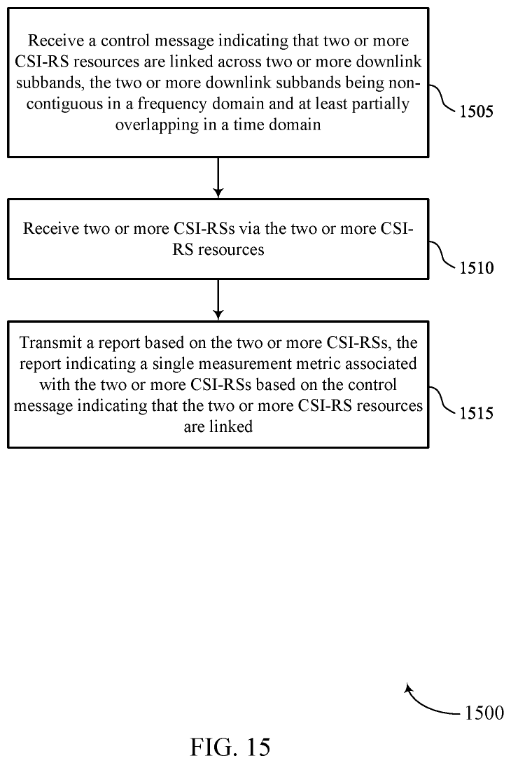

FIG. 15 shows a flowchart illustrating a method 1500 that supports SBFD CSI-RS communication in accordance with aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include receiving a control message indicating that two or more CSI-RS resources are linked across two or more downlink subbands, the two or more downlink subbands being non-contiguous in a frequency domain and at least partially overlapping in a time domain. The operations of block 1505 may be performed in accordance with examples as disclosed herein. In some examples, aspects of the operations of 1505 may be performed by a CSI-RS resource component 925 as described with reference to FIG. 9.

At 1510, the method may include receiving two or more CSI-RSs via the two or more CSI-RS resources. The operations of block 1510 may be performed in accordance with examples as disclosed herein. In some examples, aspects of the operations of 1510 may be performed by a CSI-RS component 930 as described with reference to FIG. 9.

At 1515, the method may include transmitting a report based on the two or more CSI-RSs, the report indicating a single measurement metric associated with the two or more CSI-RSs based on the control message indicating that the two or more CSI-RS resources are linked. The operations of block 1515 may be performed in accordance with examples as disclosed herein. In some examples, aspects of the operations of 1515 may be performed by a report component 935 as described with reference to FIG. 9.

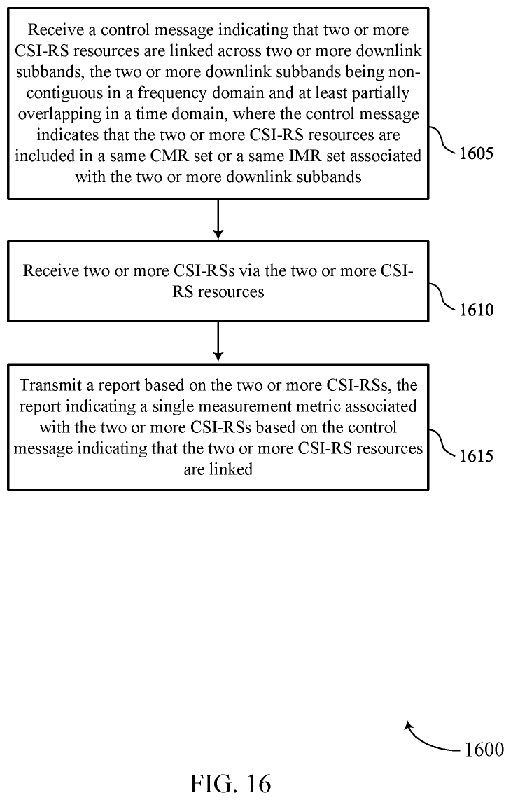

FIG. 16 shows a flowchart illustrating a method 1600 that supports SBFD CSI-RS communication in accordance with aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1605, the method may include receiving a control message indicating that two or more CSI-RS resources are linked across two or more downlink subbands, the two or more downlink subbands being non-contiguous in a frequency domain and at least partially overlapping in a time domain, where the control message indicates that the two or more CSI-RS resources are included in a same CMR set or a same IMR set associated with the two or more downlink subbands. The operations of block 1605 may be performed in accordance with examples as disclosed herein. In some examples, aspects of the operations of 1605 may be performed by a CSI-RS resource component 925 as described with reference to FIG. 9.

At 1610, the method may include receiving two or more CSI-RSs via the two or more CSI-RS resources. The operations of block 1610 may be performed in accordance with examples as disclosed herein. In some examples, aspects of the operations of 1610 may be performed by a CSI-RS component 930 as described with reference to FIG. 9.

At 1615, the method may include transmitting a report based on the two or more CSI-RSs, the report indicating a single measurement metric associated with the two or more CSI-RSs based on the control message indicating that the two or more CSI-RS resources are linked. The operations of block 1615 may be performed in accordance with examples as disclosed herein. In some examples, aspects of the operations of 1615 may be performed by a report component 935 as described with reference to FIG. 9.

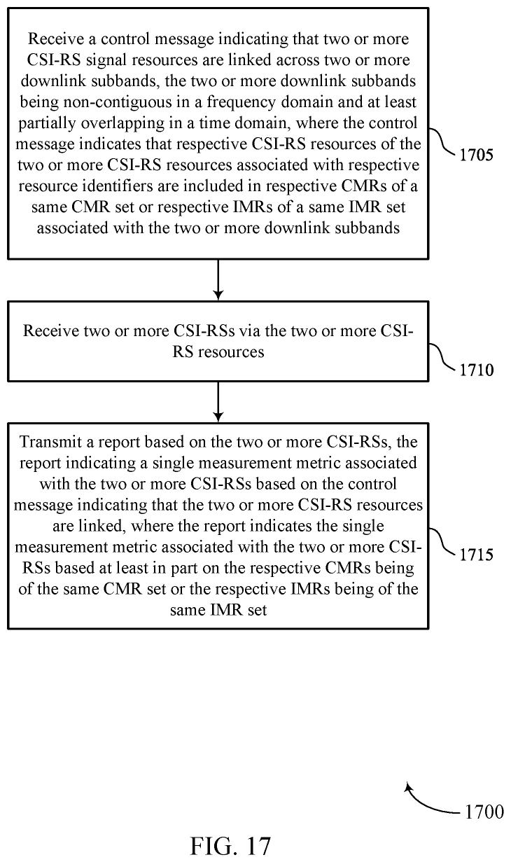

FIG. 17 shows a flowchart illustrating a method 1700 that supports SBFD CSI-RS communication in accordance with aspects of the present disclosure. The operations of the method 1700 may be implemented by a UE or its components as described herein. For example, the operations of the method 1700 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1705, the method may include receiving a control message indicating that two or more CSI-RS signal resources are linked across two or more downlink subbands, the two or more downlink subbands being non-contiguous in a frequency domain and at least partially overlapping in a time domain, where the control message indicates that respective CSI-RS resources of the two or more CSI-RS resources associated with respective resource identifiers are included in respective CMRs of a same CMR set or respective IMRs of a same IMR set associated with the two or more downlink subbands. The operations of block 1705 may be performed in accordance with examples as disclosed herein. In some examples, aspects of the operations of 1705 may be performed by a CSI-RS resource component 925 as described with reference to FIG. 9.

At 1710, the method may include receiving two or more CSI-RSs via the two or more CSI-RS resources. The operations of block 1710 may be performed in accordance with examples as disclosed herein. In some examples, aspects of the operations of 1710 may be performed by a CSI-RS component 930 as described with reference to FIG. 9.

At 1715, the method may include transmitting a report based on the two or more CSI-RSs, the report indicating a single measurement metric associated with the two or more CSI-RSs based on the control message indicating that the two or more CSI-RS resources are linked, where the report indicates the single measurement metric associated with the two or more CSI-RSs based at least in part on the respective CMRs being of the same CMR set or the respective IMRs being of the same IMR set. The operations of block 1715 may be performed in accordance with examples as disclosed herein. In some examples, aspects of the operations of 1715 may be performed by a report component 935 as described with reference to FIG. 9.

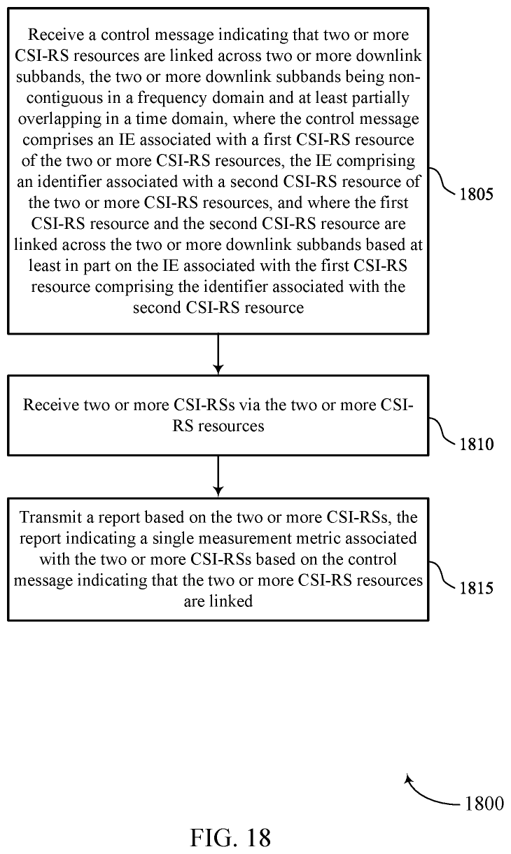

FIG. 18 shows a flowchart illustrating a method 1800 that supports SBFD CSI-RS communication in accordance with aspects of the present disclosure. The operations of the method 1800 may be implemented by a UE or its components as described herein. For example, the operations of the method 1800 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1805, the method may include receiving a control message indicating that two or more CSI-RS resources are linked across two or more downlink subbands, the two or more downlink subbands being non-contiguous in a frequency domain and at least partially overlapping in a time domain, where the control message comprises an IE associated with a first CSI-RS resource of the two or more CSI-RS resources, the IE comprising an identifier associated with a second CSI-RS resource of the two or more CSI-RS resources, and where the first CSI-RS resource and the second CSI-RS resource are linked across the two or more downlink subbands based at least in part on the IE associated with the first CSI-RS resource comprising the identifier associated with the second CSI-RS resource. The operations of block 1805 may be performed in accordance with examples as disclosed herein. In some examples, aspects of the operations of 1805 may be performed by a CSI-RS resource component 925 as described with reference to FIG. 9.

At 1810, the method may include receiving two or more CSI-RSs via the two or more CSI-RS resources. The operations of block 1810 may be performed in accordance with examples as disclosed herein. In some examples, aspects of the operations of 1810 may be performed by a CSI-RS component 930 as described with reference to FIG. 9.

At 1815, the method may include transmitting a report based on the two or more CSI-RSs, the report indicating a single measurement metric associated with the two or more CSI-RSs based on the control message indicating that the two or more CSI-RS resources are linked. The operations of block 1815 may be performed in accordance with examples as disclosed herein. In some examples, aspects of the operations of 1815 may be performed by a report component 935 as described with reference to FIG. 9.

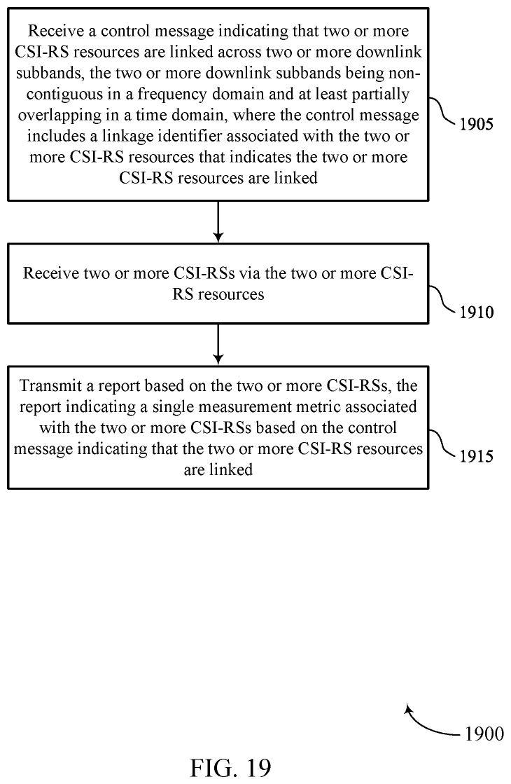

FIG. 19 shows a flowchart illustrating a method 1900 that supports SBFD CSI-RS communication in accordance with aspects of the present disclosure. The operations of the method 1900 may be implemented by a UE or its components as described herein. For example, the operations of the method 1900 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1905, the method may include receiving a control message indicating that two or more CSI-RS resources are linked across two or more downlink subbands, the two or more downlink subbands being non-contiguous in a frequency domain and at least partially overlapping in a time domain, where the control message includes a linkage identifier associated with the two or more CSI-RS resources that indicates the two or more CSI-RS resources are linked. The operations of block 1905 may be performed in accordance with examples as disclosed herein. In some examples, aspects of the operations of 1905 may be performed by a CSI-RS resource component 925 as described with reference to FIG. 9.

At 1910, the method may include receiving two or more CSI-RSs via the two or more CSI-RS resources. The operations of block 1910 may be performed in accordance with examples as disclosed herein. In some examples, aspects of the operations of 1910 may be performed by a CSI-RS component 930 as described with reference to FIG. 9.

At 1915, the method may include transmitting a report based on the two or more CSI-RSs, the report indicating a single measurement metric associated with the two or more CSI-RSs based on the control message indicating that the two or more CSI-RS resources are linked. The operations of block 1915 may be performed in accordance with examples as disclosed herein. In some examples, aspects of the operations of 1915 may be performed by a report component 935 as described with reference to FIG. 9.

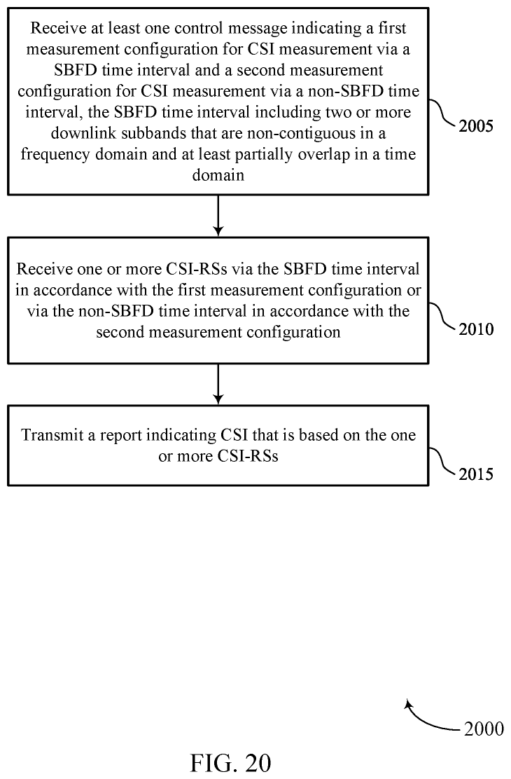

FIG. 20 shows a flowchart illustrating a method 2000 that supports SBFD CSI-RS communication in accordance with aspects of the present disclosure. The operations of the method 2000 may be implemented by a UE or its components as described herein. For example, the operations of the method 2000 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 2005, the method may include receiving at least one control message indicating a first measurement configuration for CSI measurement via a SBFD time interval and a second measurement configuration for CSI measurement via a non-SBFD time interval, the SBFD time interval including two or more downlink subbands that are non-contiguous in a frequency domain and at least partially overlap in a time domain. The operations of block 2005 may be performed in accordance with examples as disclosed herein. In some examples, aspects of the operations of 2005 may be performed by a measurement component 940 as described with reference to FIG. 9.

At 2010, the method may include receiving one or more CSI-RSs via the SBFD time interval in accordance with the first measurement configuration or via the non-SBFD time interval in accordance with the second measurement configuration. The operations of block 2010 may be performed in accordance with examples as disclosed herein. In some examples, aspects of the operations of 2010 may be performed by a CSI-RS component 930 as described with reference to FIG. 9.

At 2015, the method may include transmitting a report indicating CSI that is based on the one or more CSI-RSs. The operations of block 2015 may be performed in accordance with examples as disclosed herein. In some examples, aspects of the operations of 2015 may be performed by a report component 935 as described with reference to FIG. 9.

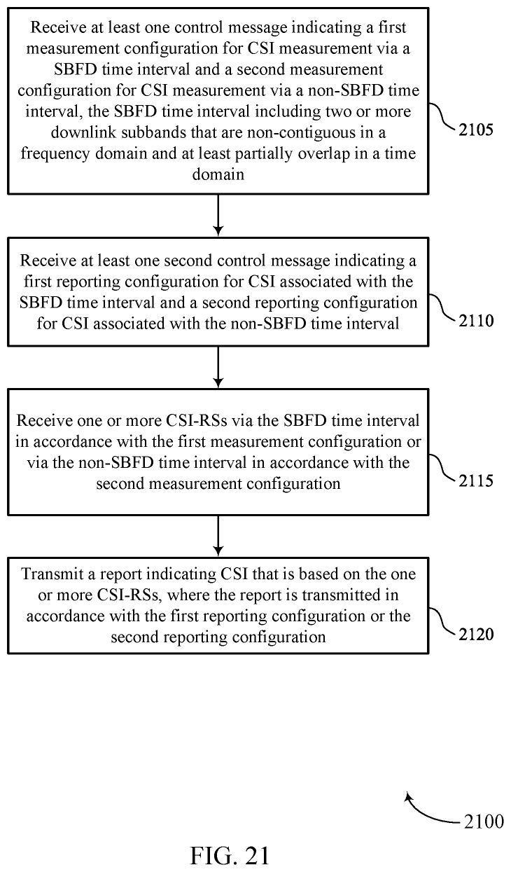

FIG. 21 shows a flowchart illustrating a method 2100 that supports SBFD CSI-RS communication in accordance with aspects of the present disclosure. The operations of the method 2100 may be implemented by a UE or its components as described herein. For example, the operations of the method 2100 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 2105, the method may include receiving at least one control message indicating a first measurement configuration for CSI measurement via a SBFD time interval and a second measurement configuration for CSI measurement via a non-SBFD time interval, the SBFD time interval including two or more downlink subbands that are non-contiguous in a frequency domain and at least partially overlap in a time domain. The operations of block 2105 may be performed in accordance with examples as disclosed herein. In some examples, aspects of the operations of 2105 may be performed by a measurement component 940 as described with reference to FIG. 9.

At 2110, the method may include receiving at least one second control message indicating a first reporting configuration for CSI associated with the SBFD time interval and a second reporting configuration for CSI associated with the non-SBFD time interval. The operations of block 2110 may be performed in accordance with examples as disclosed herein. In some examples, aspects of the operations of 2110 may be performed by a report component 935 as described with reference to FIG. 9.

At 2115, the method may include receiving one or more CSI-RSs via the SBFD time interval in accordance with the first measurement configuration or via the non-SBFD time interval in accordance with the second measurement configuration. The operations of block 2115 may be performed in accordance with examples as disclosed herein. In some examples, aspects of the operations of 2115 may be performed by a CSI-RS component 930 as described with reference to FIG. 9.

At 2120, the method may include transmitting a report indicating CSI that is based on the one or more CSI-RSs, where the report is transmitted in accordance with the first reporting configuration or the second reporting configuration. The operations of block 2120 may be performed in accordance with examples as disclosed herein. In some examples, aspects of the operations of 2120 may be performed by a report component 935 as described with reference to FIG. 9.

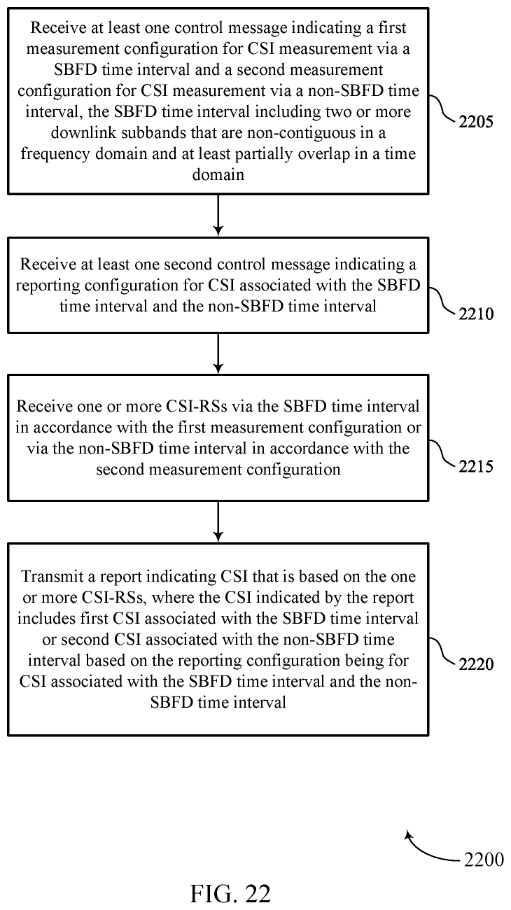

FIG. 22 shows a flowchart illustrating a method 2200 that supports SBFD CSI-RS communication in accordance with aspects of the present disclosure. The operations of the method 2200 may be implemented by a UE or its components as described herein. For example, the operations of the method 2200 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 2205, the method may include receiving at least one control message indicating a first measurement configuration for CSI measurement via a SBFD time interval and a second measurement configuration for CSI measurement via a non-SBFD time interval, the SBFD time interval including two or more downlink subbands that are non-contiguous in a frequency domain and at least partially overlap in a time domain. The operations of block 2205 may be performed in accordance with examples as disclosed herein. In some examples, aspects of the operations of 2205 may be performed by a measurement component 940 as described with reference to FIG. 9.

At 2210, the method may include receiving at least one second control message indicating a reporting configuration for CSI associated with the SBFD time interval and the non-SBFD time interval. The operations of block 2210 may be performed in accordance with examples as disclosed herein. In some examples, aspects of the operations of 2210 may be performed by a report component 935 as described with reference to FIG. 9.

At 2215, the method may include receiving one or more CSI-RSs via the SBFD time interval in accordance with the first measurement configuration or via the non-SBFD time interval in accordance with the second measurement configuration. The operations of block 2215 may be performed in accordance with examples as disclosed herein. In some examples, aspects of the operations of 2215 may be performed by a CSI-RS component 930 as described with reference to FIG. 9.

At 2220, the method may include transmitting a report indicating CSI that is based on the one or more CSI-RSs, where the CSI indicated by the report includes first CSI associated with the SBFD time interval or second CSI associated with the non-SBFD time interval based on the reporting configuration being for CSI associated with the SBFD time interval and the non-SBFD time interval. The operations of block 2220 may be performed in accordance with examples as disclosed herein. In some examples, aspects of the operations of 2220 may be performed by a report component 935 as described with reference to FIG. 9.

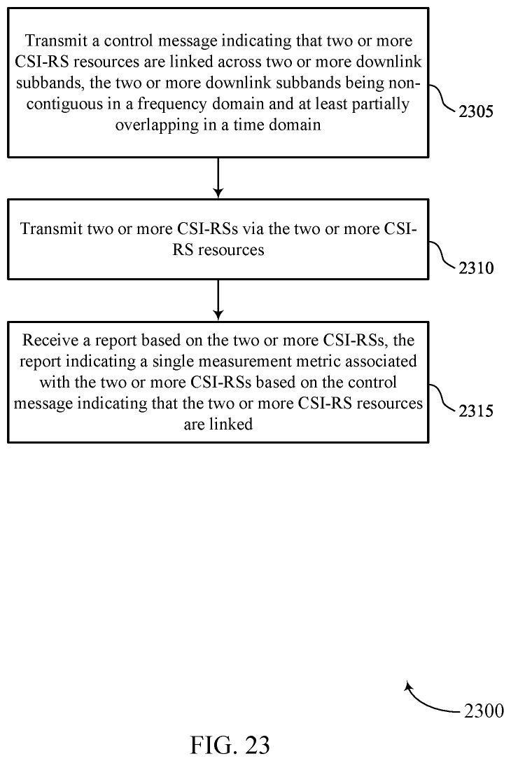

FIG. 23 shows a flowchart illustrating a method 2300 that supports SBFD CSI-RS communication in accordance with aspects of the present disclosure. The operations of the method 2300 may be implemented by a network entity or its components as described herein. For example, the operations of the method 2300 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 2305, the method may include transmitting a control message indicating that two or more CSI-RS resources are linked across two or more downlink subbands, the two or more downlink subbands being non-contiguous in a frequency domain and at least partially overlapping in a time domain. The operations of block 2305 may be performed in accordance with examples as disclosed herein. In some examples, aspects of the operations of 2305 may be performed by a CSI-RS resource component 1325 as described with reference to FIG. 13.

At 2310, the method may include transmitting two or more CSI-RSs via the two or more CSI-RS resources. The operations of block 2310 may be performed in accordance with examples as disclosed herein. In some examples, aspects of the operations of 2310 may be performed by a CSI-RS component 1330 as described with reference to FIG. 13.

At 2315, the method may include receiving a report based on the two or more CSI-RSs, the report indicating a single measurement metric associated with the two or more CSI-RSs based on the control message indicating that the two or more CSI-RS resources are linked. The operations of block 2315 may be performed in accordance with examples as disclosed herein. In some examples, aspects of the operations of 2315 may be performed by a report component 1335 as described with reference to FIG. 13.

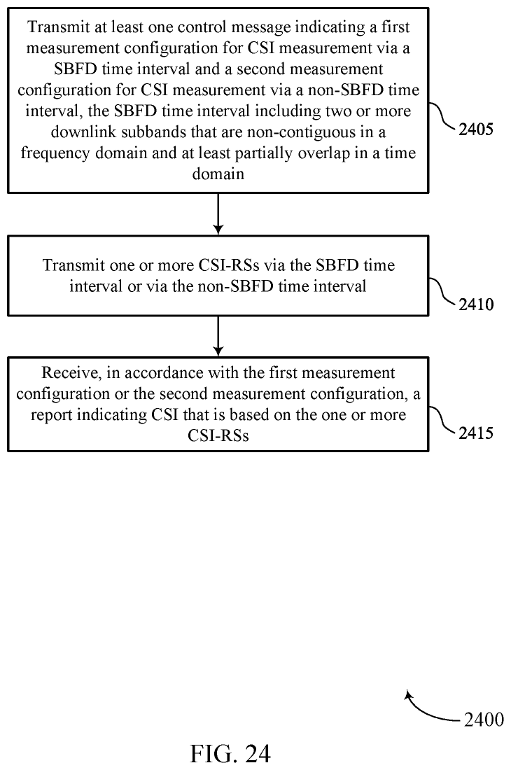

FIG. 24 shows a flowchart illustrating a method 2400 that supports SBFD CSI-RS communication in accordance with aspects of the present disclosure. The operations of the method 2400 may be implemented by a network entity or its components as described herein. For example, the operations of the method 2400 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 2405, the method may include transmitting at least one control message indicating a first measurement configuration for CSI measurement via a SBFD time interval and a second measurement configuration for CSI measurement via a non-SBFD time interval, the SBFD time interval including two or more downlink subbands that are non-contiguous in a frequency domain and at least partially overlap in a time domain. The operations of block 2405 may be performed in accordance with examples as disclosed herein. In some examples, aspects of the operations of 2405 may be performed by a measurement component 1340 as described with reference to FIG. 13.

At 2410, the method may include transmitting one or more CSI-RSs via the SBFD time interval or via the non-SBFD time interval. The operations of block 2410 may be performed in accordance with examples as disclosed herein. In some examples, aspects of the operations of 2410 may be performed by a CSI-RS component 1330 as described with reference to FIG. 13.

At 2415, the method may include receiving, in accordance with the first measurement configuration or the second measurement configuration, a report indicating CSI that is based on the one or more CSI-RSs. The operations of block 2415 may be performed in accordance with examples as disclosed herein. In some examples, aspects of the operations of 2415 may be performed by a report component 1335 as described with reference to FIG. 13.

The following provides an overview of aspects of the present disclosure:

Aspect 1: A method for wireless communications at a UE, comprising: receiving a control message indicating that two or more CSI-RS resources are linked across two or more downlink subbands, the two or more downlink subbands being non-contiguous in a frequency domain and at least partially overlapping in a time domain; receiving two or more CSI-RSs via the two or more CSI-RS resources; and transmitting a report based at least in part on the two or more CSI-RSs, the report indicating a single measurement metric associated with the two or more CSI-RSs based at least in part on the control message indicating that the two or more CSI-RS resources are linked.

Aspect 2: The method of aspect 1, wherein the two or more CSI-RS resources are linked in a same CSI reporting configuration indicated by the control message.

Aspect 3: The method of any of aspects 1 through 2, wherein the control message indicates that the two or more CSI-RS resources are included in a same CMR set or a same IMR set associated with the two or more downlink subbands.

Aspect 4: The method of any of aspects 1 through 2, wherein the control message indicates that respective CSI-RS resources of the two or more CSI-RS resources associated with respective resource identifiers are included in respective CMRs of a same CMR set or respective IMRs of a same IMR set associated with the two or more downlink subbands, and the report indicates the single measurement metric associated with the two or more CSI-RSs based at least in part on the respective CMRs being of the same CMR set or the respective IMRs being of the same IMR set.

Aspect 5: The method of aspect 4, wherein the control message comprises a flag indicating that the respective CMRs or the respective IMRs are linked across the two or more downlink subbands.

Aspect 6: The method of any of aspects 4 through 5, wherein the control message indicates two CMRs and a single IMR, and the single measurement metric corresponds to an average of respective measurement metrics associated with the two CMRs divided by a measurement metric associated with the single IMR.

Aspect 7: The method of any of aspects 4 through 5, wherein the control message indicates two CMRs and two IMRs, and the single measurement metric corresponds to a first average of respective measurement metrics associated with the two CMRs divided by a second average of respective measurement metrics associated with the two IMRs.

Aspect 8: The method of aspect 7, wherein the control message indicates the two CMR and two IMRs in accordance with a rule that the control message indicates a same quantity of CMRs and IMRs as downlink subbands across which CSI-RS resources are linked.

Aspect 9: The method of aspect 1, wherein the control message comprises an IE associated with a first CSI-RS resource of the two or more CSI-RS resources, the IE comprising an identifier associated with a second CSI-RS resource of the two or more CSI-RS resources, and the first CSI-RS resource and the second CSI-RS resource are linked across the two or more downlink subbands based at least in part on the IE associated with the first CSI-RS resource comprising the identifier associated with the second CSI-RS resource.

Aspect 10: The method of aspect 1, wherein the control message includes a linkage identifier associated with the two or more CSI-RS resources that indicates the two or more CSI-RS resources are linked.

Aspect 11: The method of aspect 10, further comprising: receiving a second control message comprising an IE indicating a set of linkage identifiers comprising the linkage identifier, each linkage identifier associated with a respective set of two or more CSI-RS resources that are linked, wherein the control message includes the linkage identifier from the set of linkage identifiers indicated by the second control message.

Aspect 12: The method of any of aspects 10 through 11, further comprising: receiving a second control message that updates a linkage of CSI-RSs across the two or more downlink subbands to two or more second CSI-RS resources based at least in part on indicating a second linkage identifier associated with the two or more second CSI-RS resources; receiving two or more second CSI-RSs via the two or more second CSI-RS resources based at least in part on the second control message; and transmitting a second report based at least in part on the two or more second CSI-RSs, the second report indicating a single second measurement metric associated with the two or more second CSI-RSs.

Aspect 13: The method of aspect 12, wherein the second control message comprises a MAC-CE or DCI.

Aspect 14: The method of any of aspects 10 through 11, further comprising: receiving a second control message that updates a linkage of CSI-RSs across the two or more downlink subbands to two or more second CSI-RS resources based at least in part on indicating respective CSI-RS resource identifiers associated with the two or more second CSI-RS resources; receiving two or more second CSI-RSs via the two or more second CSI-RS resources based at least in part on the second control message; and transmitting a second report based at least in part on the two or more second CSI-RSs, the second report indicating a single second measurement metric associated with the two or more second CSI-RSs.

Aspect 15: The method of aspect 14, further comprising: removing a linkage of a first CSI-RS resource and a second CSI-RS resource of the two or more CSI-RS resources based at least in part on a CSI-RS resource identifier associated with the first CSI-RS resource being indicated by the second control message.

Aspect 16: The method of any of aspects 14 through 15, wherein the second control message comprises a MAC-CE or DCI.

Aspect 17: The method of any of aspects 1 through 16, wherein one or more uplink subbands that overlap in a SBFD symbol with the two or more downlink subbands in the time domain are located between respective downlink subbands of the two or more downlink subbands in the frequency domain.

Aspect 18: A method for wireless communications at a UE, comprising: receiving at least one control message indicating a first measurement configuration for CSI measurement via a SBFD time interval and a second measurement configuration for CSI measurement via a non-SBFD time interval, the SBFD time interval comprising two or more downlink subbands that are non-contiguous in a frequency domain and at least partially overlap in a time domain; receiving one or more CSI-RSs via the SBFD time interval in accordance with the first measurement configuration or via the non-SBFD time interval in accordance with the second measurement configuration; and transmitting a report indicating CSI that is based at least in part on the one or more CSI-RSs.

Aspect 19: The method of aspect 18, wherein the first measurement configuration indicates a first quantity of antenna ports or a first antenna configuration to use for CSI measurement via the SBFD time interval, and the second measurement configuration indicates a second quantity of antenna ports or a second antenna configuration to use for CSI measurement via the non-SBFD time interval.

Aspect 20: The method of any of aspects 18 through 19, wherein the first measurement configuration indicates a first TCI state associated with CSI measurement via the SBFD time interval, and the second measurement configuration indicates a second TCI state associated with CSI measurement via the non-SBFD time interval.

Aspect 21: The method of aspect 20, wherein the first TCI state is associated with first QCL information associated with the SBFD time interval, and the second TCI state is associated with second QCL information associated with the non-SBFD time interval.

Aspect 22: The method of any of aspects 18 through 21, further comprising: receiving at least one second control message indicating a first reporting configuration for CSI associated with the SBFD time interval and a second reporting configuration for CSI associated with the non-SBFD time interval, wherein the report is transmitted in accordance with the first reporting configuration or the second reporting configuration.

Aspect 23: The method of aspect 22, wherein the first reporting configuration indicates for the UE to measure CSI-RSs received via the SBFD time interval and to refrain from measuring CSI-RSs received via the non-SBFD time interval, the second reporting configuration indicates for the UE to refrain from measuring CSI-RSs received via the SBFD time interval and to measure CSI-RSs received via the non-SBFD time interval, and the one or more CSI-RSs are measured in accordance with the first reporting configuration or the second reporting configuration.

Aspect 24: The method of any of aspects 18 through 21, further comprising: receiving at least one second control message indicating a reporting configuration for CSI associated with the SBFD time interval and the non-SBFD time interval, wherein the CSI indicated by the report comprises first CSI associated with the SBFD time interval or second CSI associated with the non-SBFD time interval based at least in part on the reporting configuration being for CSI associated with the SBFD time interval and the non-SBFD time interval.

Aspect 25: The method of aspect 24, further comprising: disabling, based at least in part on the reporting configuration being for CSI associated with the SBFD time interval and the non-SBFD time interval, averaging the first CSI associated with the SBFD time interval and the second CSI associated with the non-SBFD time interval.

Aspect 26: The method of any of aspects 18 through 25, wherein one or more uplink subbands that overlap in a SBFD symbol with the two or more downlink subbands in the time domain are located between respective downlink subbands of the two or more downlink subbands in the frequency domain.

Aspect 27: A method for wireless communications at a network entity, comprising: transmitting a control message indicating that two or more CSI-RS resources are linked across two or more downlink subbands, the two or more downlink subbands being non-contiguous in a frequency domain and at least partially overlapping in a time domain; transmitting two or more CSI-RSs via the two or more CSI-RS resources; and receiving a report based at least in part on the two or more CSI-RSs, the report indicating a single measurement metric associated with the two or more CSI-RSs based at least in part on the control message indicating that the two or more CSI-RS resources are linked.

Aspect 28: The method of aspect 27, wherein the two or more CSI-RS resources are linked in a same CSI reporting configuration indicated by the control message.

Aspect 29: The method of any of aspects 27 through 28, wherein the control message indicates that the two or more CSI-RS resources are included in a same CMR set or a same IMR set associated with the two or more downlink subbands.

Aspect 30: The method of any of aspects 27 through 28, wherein the control message indicates that respective CSI-RS resources of the two or more CSI-RS resources associated with respective resource identifiers are included in respective CMRs of a same CMR set or respective IMRs of a same IMR set associated with the two or more downlink subbands, and the report indicates the single measurement metric associated with the two or more CSI-RSs based at least in part on the respective CMRs being of the same CMR set or the respective IMRs being of the same IMR set.

Aspect 31: The method of aspect 30, wherein the control message comprises a flag indicating that the respective CMRs or the respective IMRs are linked across the two or more downlink subbands.

Aspect 32: The method of any of aspects 30 through 31, wherein the control message indicates two CMRs and a single IMR, and the single measurement metric corresponds to an average of respective measurement metrics associated with the two CMRs divided by a measurement metric associated with the single IMR.

Aspect 33: The method of any of aspects 27 through 31, wherein the control message indicates two CMRs and two IMRs, and the single measurement metric corresponds to a first average of respective measurement metrics associated with the two CMRs divided by a second average of respective measurement metrics associated with the two IMRs.

Aspect 34: The method of aspect 33, wherein the control message indicates the two CMR and two IMRs in accordance with a rule that the control message indicates a same quantity of CMRs and IMRs as downlink subbands across which CSI-RS resources are linked.

Aspect 35: The method of aspect 27, wherein the control message comprises an IE associated with a first CSI-RS resource of the two or more CSI-RS resources, the IE comprising an identifier associated with a second CSI-RS resource of the two or more CSI-RS resources, and the first CSI-RS resource and the second CSI-RS resource are linked across the two or more downlink subbands based at least in part on the IE associated with the first CSI-RS resource comprising the identifier associated with the second CSI-RS resource.

Aspect 36: The method of aspect 27, wherein the control message includes a linkage identifier associated with the two or more CSI-RS resources that indicates the two or more CSI-RS resources are linked.

Aspect 37: The method of aspect 36, further comprising: transmitting a second control message comprising an IE indicating a set of linkage identifiers comprising the linkage identifier, each linkage identifier associated with a respective set of two or more CSI-RS resources that are linked, wherein the control message includes the linkage identifier from the set of linkage identifiers indicated by the second control message.

Aspect 38: The method of any of aspects 36 through 37, further comprising: transmitting a second control message that updates a linkage of CSI-RSs across the two or more downlink subbands to two or more second CSI-RS resources based at least in part on indicating a second linkage identifier associated with the two or more second CSI-RS resources; transmitting two or more second CSI-RSs via the two or more second CSI-RS resources based at least in part on the second control message; and receiving a second report based at least in part on the two or more second CSI-RSs, the second report indicating a single second measurement metric associated with the two or more second CSI-RSs.

Aspect 39: The method of aspect 38, wherein the second control message comprises a MAC-CE or DCI.

Aspect 40: The method of any of aspects 36 through 37, further comprising: transmitting a second control message that updates a linkage of CSI-RSs across the two or more downlink subbands to two or more second CSI-RS resources based at least in part on indicating respective CSI-RS resource identifiers associated with the two or more second CSI-RS resources; transmitting two or more second CSI-RSs via the two or more second CSI-RS resources based at least in part on the second control message; and receiving a second report based at least in part on the two or more second CSI-RSs, the second report indicating a single second measurement metric associated with the two or more second CSI-RSs.

Aspect 41: The method of aspect 40, further comprising: removing a linkage of a first CSI-RS resource and a second CSI-RS resource of the two or more CSI-RS resources based at least in part on a CSI-RS resource identifier associated with the first CSI-RS resource being indicated by the second control message.

Aspect 42: The method of any of aspects 40 through 41, wherein the second control message comprises a MAC-CE or DCI.

Aspect 43: The method of any of aspects 27 through 42, wherein one or more uplink subbands that overlap in a SBFD symbol with the two or more downlink subbands in the time domain are located between respective downlink subbands of the two or more downlink subbands in the frequency domain.

Aspect 44: A method for wireless communications at a network entity, comprising: transmitting at least one control message indicating a first measurement configuration for CSI measurement via a SBFD time interval and a second measurement configuration for CSI measurement via a non-SBFD time interval, the SBFD time interval comprising two or more downlink subbands that are non-contiguous in a frequency domain and at least partially overlap in a time domain; transmitting one or more CSI-RSs via the SBFD time interval or via the non-SBFD time interval; and receiving, in accordance with the first measurement configuration or the second measurement configuration, a report indicating CSI that is based at least in part on the one or more CSI-RSs.

Aspect 45: The method of aspect 44, wherein the first measurement configuration indicates a first quantity of antenna ports or a first antenna configuration to use for CSI measurement via the SBFD time interval, and the second measurement configuration indicates a second quantity of antenna ports or a second antenna configuration to use for CSI measurement via the non-SBFD time interval.

Aspect 46: The method of any of aspects 44 through 45, wherein the first measurement configuration indicates a first TCI state associated with CSI measurement via the SBFD time interval, and the second measurement configuration indicates a second TCI state associated with CSI measurement via the non-SBFD time interval.

Aspect 47: The method of aspect 46, wherein the first TCI state is associated with first QCL information associated with the SBFD time interval, and the second TCI state is associated with second QCL information associated with the non-SBFD time interval.

Aspect 48: The method of any of aspects 44 through 47, further comprising: transmitting at least one second control message indicating a first reporting configuration for CSI associated with the SBFD time interval and a second reporting configuration for CSI associated with the non-SBFD time interval, wherein the report is received in accordance with the first reporting configuration or the second reporting configuration.

Aspect 49: The method of aspect 48, wherein the first reporting configuration indicates for measurement of CSI-RSs transmitted via the SBFD time interval and lack of measurement of CSI-RSs transmitted via the non-SBFD time interval, the second reporting configuration indicates for measurement of CSI-RSs transmitted via the SBFD time interval and lack of measurement of CSI-RSs transmitted via the non-SBFD time interval.

Aspect 50: The method of any of aspects 44 through 47, further comprising: transmitting at least one second control message indicating a reporting configuration for CSI associated with the SBFD time interval and the non-SBFD time interval, wherein the CSI indicated by the report comprises first CSI associated with the SBFD time interval or second CSI associated with the non-SBFD time interval based at least in part on the reporting configuration being for CSI associated with the SBFD time interval and the non-SBFD time interval.

Aspect 51: The method of aspect 50, further comprising: determining whether the report comprises the first CSI or the second CSI based at least in part on whether the one or more CSI-RSs are transmitted via the SBFD time interval or the non-SBFD time interval.

Aspect 52: The method of any of aspects 44 through 51, wherein one or more uplink subbands that overlap in a SBFD symbol with the two or more downlink subbands in the time domain are located between respective downlink subbands of the two or more downlink subbands in the frequency domain.

Aspect 53: An apparatus for wireless communications at a UE, comprising a processor; memory coupled with the processor; and instructions stored in the memory and executable by the processor to cause the apparatus to perform a method of any of aspects 1 through 17.

Aspect 54: An apparatus for wireless communications at a UE, comprising at least one means for performing a method of any of aspects 1 through 17.

Aspect 55: A non-transitory computer-readable medium storing code for wireless communications at a UE, the code comprising instructions executable by a processor to perform a method of any of aspects 1 through 17.

Aspect 56: An apparatus for wireless communications at a UE, comprising a processor; memory coupled with the processor; and instructions stored in the memory and executable by the processor to cause the apparatus to perform a method of any of aspects 18 through 26.

Aspect 57: An apparatus for wireless communications at a UE, comprising at least one means for performing a method of any of aspects 18 through 26.

Aspect 58: A non-transitory computer-readable medium storing code for wireless communications at a UE, the code comprising instructions executable by a processor to perform a method of any of aspects 18 through 26.

Aspect 59: An apparatus for wireless communications at a network entity, comprising a processor; memory coupled with the processor; and instructions stored in the memory and executable by the processor to cause the apparatus to perform a method of any of aspects 27 through 43.

Aspect 60: An apparatus for wireless communications at a network entity, comprising at least one means for performing a method of any of aspects 27 through 43.

Aspect 61: A non-transitory computer-readable medium storing code for wireless communications at a network entity, the code comprising instructions executable by a processor to perform a method of any of aspects 27 through 43.

Aspect 62: An apparatus for wireless communications at a network entity, comprising a processor; memory coupled with the processor; and instructions stored in the memory and executable by the processor to cause the apparatus to perform a method of any of aspects 44 through 52.

Aspect 63: An apparatus for wireless communications at a network entity, comprising at least one means for performing a method of any of aspects 44 through 52.

Aspect 64: A non-transitory computer-readable medium storing code for wireless communications at a network entity, the code comprising instructions executable by a processor to perform a method of any of aspects 44 through 52.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a user equipment (UE), comprising:
a processor;
memory coupled with the processor; and
instructions stored in the memory and executable by the processor to cause the apparatus to:
receive a control message indicating that two or more channel state information reference signal resources are linked across two or more downlink subbands, the two or more downlink subbands being non-contiguous in a frequency domain and at least partially overlapping in a time domain;
receive two or more channel state information reference signals via the two or more channel state information reference signal resources; and
transmit a report based at least in part on the two or more channel state information reference signals, the report indicating a single measurement metric associated with the two or more channel state information reference signals based at least in part on the control message indicating that the two or more channel state information reference signal resources are linked.

2. The apparatus of claim 1, wherein the two or more channel state information reference signal resources are linked in a same channel state information reporting configuration indicated by the control message.

3. The apparatus of claim 1, wherein the control message indicates that the two or more channel state information reference signal resources are included in a same channel measurement resource set or a same interference measurement resource set associated with the two or more downlink subbands.

4. The apparatus of claim 1, wherein:
the control message indicates that respective channel state information reference signal resources of the two or more channel state information reference signal resources associated with respective resource identifiers are included in respective channel measurement resources of a same channel measurement resource set or respective interference measurement resources of a same interference measurement resource set associated with the two or more downlink subbands, and
the report indicates the single measurement metric associated with the two or more channel state information reference signals based at least in part on the respective channel measurement resources being of the same channel measurement resource set or the respective interference measurement resources being of the same interference measurement resource set.

5. The apparatus of claim 4, wherein the control message comprises a flag indicating that the respective channel measurement resources or the respective interference measurement resources are linked across the two or more downlink subbands.

6. The apparatus of claim 4, wherein:
the control message indicates two channel measurement resources and a single interference measurement resource, and
the single measurement metric corresponds to an average of respective measurement metrics associated with the two channel measurement resources divided by a measurement metric associated with the single interference measurement resource.

7. The apparatus of claim 4, wherein:
the control message indicates two channel measurement resources and two interference measurement resources, and
the single measurement metric corresponds to a first average of respective measurement metrics associated with the two channel measurement resources divided by a second average of respective measurement metrics associated with the two interference measurement resources.

8. The apparatus of claim 7, wherein the control message indicates the two channel measurement resources and two interference measurement resources in accordance with a rule that the control message indicates a same quantity of channel measurement resources and interference measurement resources as downlink subbands across which channel state information reference signal resources are linked.

9. The apparatus of claim 1, wherein:
the control message comprises an information element associated with a first channel state information reference signal resource of the two or more channel state information reference signal resources, the information element comprising an identifier associated with a second channel state information reference signal resource of the two or more channel state information reference signal resources, and
the first channel state information reference signal resource and the second channel state information reference signal resource are linked across the two or more downlink subbands based at least in part on the information element associated with the first channel state information reference signal resource comprising the identifier associated with the second channel state information reference signal resource.

10. The apparatus of claim 1, wherein the control message includes a linkage identifier associated with the two or more channel state information reference signal resources that indicates the two or more channel state information reference signal resources are linked.

11. The apparatus of claim 10, wherein the instructions are further executable by the processor to cause the apparatus to:
receive a second control message comprising an information element indicating a set of linkage identifiers comprising the linkage identifier, each linkage identifier associated with a respective set of two or more channel state information reference signal resources that are linked,
wherein the control message includes the linkage identifier from the set of linkage identifiers indicated by the second control message.

12. The apparatus of claim 10, wherein the instructions are further executable by the processor to cause the apparatus to:
receive a second control message that updates a linkage of channel state information reference signals across the two or more downlink subbands to two or more second channel state information reference signal resources based at least in part on indicating a second linkage identifier associated with the two or more second channel state information reference signal resources;
receive two or more second channel state information reference signals via the two or more second channel state information reference signal resources based at least in part on the second control message; and
transmit a second report based at least in part on the two or more second channel state information reference signals, the second report indicating a single second measurement metric associated with the two or more second channel state information reference signals.

13. The apparatus of claim 12, wherein the second control message comprises a medium access control-control element or downlink control information.

14. The apparatus of claim 10, wherein the instructions are further executable by the processor to cause the apparatus to:
receive a second control message that updates a linkage of channel state information reference signals across the two or more downlink subbands to two or more second channel state information reference signal resources based at least in part on indicating respective channel state information reference signal resource identifiers associated with the two or more second channel state information reference signal resources;
receive two or more second channel state information reference signals via the two or more second channel state information reference signal resources based at least in part on the second control message; and
transmit a second report based at least in part on the two or more second channel state information reference signals, the second report indicating a single second measurement metric associated with the two or more second channel state information reference signals.

15. The apparatus of claim 14, wherein the instructions are further executable by the processor to cause the apparatus to:
remove a linkage of a first channel state information reference signal resource and a second channel state information reference signal resource of the two or more channel state information reference signal resources based at least in part on a channel state information reference signal resource identifier associated with the first channel state information reference signal resource being indicated by the second control message.

16. The apparatus of claim 14, wherein the second control message comprises a medium access control-control element or downlink control information.

17. The apparatus of claim 1, wherein one or more uplink subbands that overlap in a subband full duplex symbol with the two or more downlink subbands in the time domain are located between respective downlink subbands of the two or more downlink subbands in the frequency domain.

18. An apparatus for wireless communications at a user equipment (UE), comprising:
a processor;
memory coupled with the processor; and
instructions stored in the memory and executable by the processor to cause the apparatus to:
receive at least one control message indicating a first measurement configuration for channel state information measurement via a subband full duplex time interval and a second measurement configuration for channel state information measurement via a non-subband full duplex time interval, the subband full duplex time interval comprising two or more downlink subbands that are non-contiguous in a frequency domain and at least partially overlap in a time domain;
receive one or more channel state information reference signals via the subband full duplex time interval in accordance with the first measurement configuration or via the non-subband full duplex time interval in accordance with the second measurement configuration; and
transmit a report indicating channel state information that is based at least in part on the one or more channel state information reference signals.

19. The apparatus of claim 18, wherein:
the first measurement configuration indicates a first quantity of antenna ports or a first antenna configuration to use for channel state information measurement via the subband full duplex time interval, and
the second measurement configuration indicates a second quantity of antenna ports or a second antenna configuration to use for channel state information measurement via the non-subband full duplex time interval.

20. The apparatus of claim 18, wherein:
the first measurement configuration indicates a first transmission configuration indicator state associated with channel state information measurement via the subband full duplex time interval and with first quasi co location information associated with the subband full duplex time interval, and
the second measurement configuration indicates a second transmission configuration indicator state associated with channel state information measurement via the non-subband full duplex time interval and with second quasi co location information associated with the non-subband full duplex time interval.

21. The apparatus of claim 18, wherein the instructions are further executable by the processor to cause the apparatus to:
receive at least one second control message indicating a first reporting configuration for channel state information associated with the subband full duplex time interval and a second reporting configuration for channel state information associated with the non-subband full duplex time interval,
wherein the report is transmitted in accordance with the first reporting configuration or the second reporting configuration.

22. The apparatus of claim 21, wherein:
the first reporting configuration indicates for the UE to measure channel state information reference signals received via the subband full duplex time interval and to refrain from measuring channel state information reference signals received via the non-subband full duplex time interval,
the second reporting configuration indicates for the UE to refrain from measuring channel state information reference signals received via the subband full duplex time interval and to measure channel state information reference signals received via the non-subband full duplex time interval, and
the one or more channel state information reference signals are measured in accordance with the first reporting configuration or the second reporting configuration.

23. The apparatus of claim 18, wherein the instructions are further executable by the processor to cause the apparatus to:
receive at least one second control message indicating a reporting configuration for channel state information associated with the subband full duplex time interval and the non-subband full duplex time interval,
wherein the channel state information indicated by the report comprises first channel state information associated with the subband full duplex time interval or second channel state information associated with the non-subband full duplex time interval based at least in part on the reporting configuration being for channel state information associated with the subband full duplex time interval and the non-subband full duplex time interval.

24. The apparatus of claim 23, wherein the instructions are further executable by the processor to cause the apparatus to:
disable, based at least in part on the reporting configuration being for channel state information associated with the subband full duplex time interval and the non-subband full duplex time interval, averaging the first channel state information associated with the subband full duplex time interval and the second channel state information associated with the non-subband full duplex time interval.

25. The apparatus of claim 18, wherein one or more uplink subbands that overlap in a subband full duplex symbol with the two or more downlink subbands in the time domain are located between respective downlink subbands of the two or more downlink subbands in the frequency domain.

26. An apparatus for wireless communications at a network entity, comprising:
a processor;
memory coupled with the processor; and
instructions stored in the memory and executable by the processor to cause the apparatus to:
transmit a control message indicating that two or more channel state information reference signal resources are linked across two or more downlink subbands, the two or more downlink subbands being non-contiguous in a frequency domain and at least partially overlapping in a time domain;
transmit two or more channel state information reference signals via the two or more channel state information reference signal resources; and
receive a report based at least in part on the two or more channel state information reference signals, the report indicating a single measurement metric associated with the two or more channel state information reference signals based at least in part on the control message indicating that the two or more channel state information reference signal resources are linked.

27. The apparatus of claim 26, wherein the two or more channel state information reference signal resources are linked in a same channel state information reporting configuration indicated by the control message.

28. An apparatus for wireless communications at a network entity, comprising:
a processor;
memory coupled with the processor; and
instructions stored in the memory and executable by the processor to cause the apparatus to:
transmit at least one control message indicating a first measurement configuration for channel state information measurement via a subband full duplex time interval and a second measurement configuration for channel state information measurement via a non-subband full duplex time interval, the subband full duplex time interval comprising two or more downlink subbands that are non-contiguous in a frequency domain and at least partially overlap in a time domain;
transmit one or more channel state information reference signals via the subband full duplex time interval or via the non-subband full duplex time interval; and
receive, in accordance with the first measurement configuration or the second measurement configuration, a report indicating channel state information that is based at least in part on the one or more channel state information reference signals.

29. The apparatus of claim 28, wherein the instructions are further executable by the processor to cause the apparatus to:
transmit at least one second control message indicating a reporting configuration for channel state information associated with the subband full duplex time interval and the non-subband full duplex time interval,
wherein the channel state information indicated by the report comprises first channel state information associated with the subband full duplex time interval or second channel state information associated with the non-subband full duplex time interval based at least in part on the reporting configuration being for channel state information associated with the subband full duplex time interval and the non-subband full duplex time interval.

30. The apparatus of claim 29, wherein the instructions are further executable by the processor to cause the apparatus to:
determine whether the report comprises the first channel state information or the second channel state information based at least in part on whether the one or more channel state information reference signals are transmitted via the subband full duplex time interval or the non-subband full duplex time interval.
